(19) United States
(12) Patent Application Publication
(10) Pub. No.: US 2016/0048786 A1
(43) Pub. Date: Feb. 18, 2016

(54) MANAGING A PROJECT

(71) Applicant: International Business Machines Corporation, Armonk, NY (US)

(72) Inventors: Susumu Fukuda, Tokyo (JP); Daisuke Maruyama, Kanagawa (JP); Takeshi Watanabe, Kanagawa (JP)

(21) Appl. No.: 14/791,591

(22) Filed: Jul. 6, 2015

(30) Foreign Application Priority Data
Aug. 14, 2014 (JP) 2014165335

(51) Int. Cl. G06Q 10/06; G06F 3/0354; G06F 3/0484

(52) U.S. Cl. CPC G06Q 10/06313; G06F 3/04847; G06F 3/03543

(57) ABSTRACT

A method and associated system for managing a plurality of projects. A project image representing each project is displayed in a position on a diagram for reflecting a progress status of each project. A degree of association between projects is calculated on the basis of influence information indicating that work of a project is affected by work of another project and resource information indicating resources allocated to the respective projects. A display unit displays, on the basis of the calculated degree of association between the projects, an association degree image indicating a degree of association between one project and another project in association with a project image representing the one project and a project image representing the other project on the diagram.

### TECHNICAL FIELD

The present invention relates to a system, a method, and a program for managing a project.

### BACKGROUND

Conventionally, in project management, tools such as a WBS (Work Breakdown Structure) and a Gantt chart are sometimes used in order to perform progress management of a project. In the WBS and the Gantt chart, the entire project is divided into fine processes and a flow of the entire work and a progress status of each process are shown. For example, a technique is known for retaining, on a computer, work information in work and a dependency relation of the work information and automatically generating work items and a work procedure.

### BRIEF SUMMARY

The present invention provides a system for managing a plurality of projects. The system includes: a layout unit laying out, for each project, a project image, which is an image representing that project, in a position on a diagram determined on the basis of a progress status of the project; and a display control unit laying out, using a degree of association between projects obtained on the basis of influence information indicating, for each project, that work of that project is affected by work of another project and resource information indicating resources allocated to the respective projects, an association degree image indicating a degree of association between one project and another project in association with a project image representing the one project and a project image representing the other project on the diagram ad causing a display unit to display the diagram on which the images are laid out.

The present invention provides a method for managing a plurality of projects. A project image representing each project is displayed in a position on a diagram for reflecting a progress status of each project. A degree of association between projects is calculated on the basis of influence information indicating that work of a project is affected by work of another project and resource information indicating resources allocated to the respective projects. A display unit displays, on the basis of the calculated degree of association between the projects, an association degree image indicating a degree of association between one project and another project in association with a project image representing the one project and a project image representing the other project on the diagram.

The present invention provides a program for causing a computer for managing a plurality of projects to implement: a function for laying out, for each project, a project image, which is an image representing that project, in a position on a diagram determined on the basis of a progress status of the project; a function for calculating a degree of association between projects on the basis of influence information indicating that work of a project is affected by work of another project and resource information indicating resources allocated to the respective projects; and a function for laying out, on the basis of the calculated degree of association between the projects, an association degree image indicating a degree of association between one project and another project in association with a project image representing the one project and a project image representing the other project on the diagram and causing a display unit to display the diagram on which the images are laid out.

### BRIEF DESCRIPTION OF THE DRAWINGS

FIG. 1 is a block diagram showing a functional configuration example of a project managing system in accordance with embodiments of the present invention.

FIG. 2(a) is a diagram showing an example of a project list, in accordance with embodiments of the present invention.

FIG. 2(b) is a diagram showing an example of allocations of amounts of work to persons in charge for projects, in accordance with embodiments of the present invention.

FIG. 3 is a diagram showing an example of task lists in the projects, in accordance with embodiments of the present invention.

FIG. 4 is a diagram showing an example of relation search information, in accordance with embodiments of the present invention.

FIG. 5 is a flow chart showing an example of a processing procedure for generating and displaying a progress status graph, in accordance with embodiments of the present invention.

FIG. 6(a) is a diagram showing an example of amounts of work executable by the persons in charge before the completion of the projects, in accordance with embodiments of the present invention.

FIG. 6(b) is a diagram showing an example of amounts of work that should be completed at the present point in time concerning the projects, in accordance with embodiments of the present invention.

FIG. 6(c) is a flow diagram showing an example of amounts of work actually completed concerning the projects and remaining amounts of work, in accordance with embodiments of the present invention.

FIG. 7(a) is a diagram showing an example of values indicating positions where project images of the projects are laid out and sizes of the project images, in accordance with embodiments of the present invention.

FIGS. 7(b) and 7(c) are diagrams showing an example of a graph generated on the basis of the values shown in FIG. 7(a), in accordance with embodiments of the present invention.

FIG. 8 is a diagram showing an example of a progress status graph displayed on a display screen of a display unit, in accordance with embodiments of the present invention.

FIG. 9 is a diagram showing an example of a progress status graph displayed when the allocations of the amounts of work are changed, in accordance with embodiments of the present invention.

FIGS. 10(a) to 10(c) are diagrams showing examples of data used for calculating progress differences after the allocation change of the amounts of work, in accordance with embodiments of the present invention.

FIG. 11 is a diagram showing an example of a progress status graph after the allocation change of the amounts of work, in accordance with embodiments of the present invention.

FIGS. 12(a) to 12(c) are diagrams showing examples of data used for calculating progress differences after an assignment change of the persons in charge, in accordance with embodiments of the present invention.

FIG. 13 is a diagram showing an example of a progress status graph after the assignment change of the persons in charge, in accordance with embodiments of the present invention.

FIGS. 14(a) and 14(b) are diagrams showing examples of data used for calculating progress differences after exclusion of a task b5, in accordance with embodiments of the present invention.

FIG. 15(a) is a diagram showing an example of values indicating positions where project images of the projects are laid out and sizes of the project images after the exclusion of the task b5, in accordance with embodiments of the present invention.

FIGS. 15(b) and 15(c) are diagrams showing examples of graphs generated on the basis of the values of FIG. 15(a), in accordance with embodiments of the present invention.

FIGS. 16(a) and 16(b) are diagrams showing examples of data used for calculating progress differences after exclusion of a task a8, in accordance with embodiments of the present invention.

FIG. 17(a) is a diagram showing an example of values of positions where project images of the projects are laid out and sizes of the project images after the exclusion of the task a8, in accordance with embodiments of the present invention.

FIGS. 17(b) and 17(c) are diagrams showing examples of graphs generated on the basis of the values of FIG. 17(a), in accordance with embodiments of the present invention.

FIG. 18 is a diagram showing an example of a progress status graph after exclusion of a task, in accordance with embodiments of the present invention.

FIG. 19 is a diagram showing an example of time accumulated to the present point in time in the projects, in accordance with embodiments of the present invention.

FIG. 20 is a diagram showing a hardware configuration example suitable for configuring the project managing system, in accordance with embodiments of the present invention.

FIG. 21 is a flow chart depicting a method for managing a plurality of projects, in accordance with embodiments of the present invention.

### DETAILED DESCRIPTION

During development of, for example, an application or software, in some case, a project is present for each function to be developed and a plurality of projects proceed simultaneously in parallel. When the plurality of projects proceed in parallel, in some case, the progress of a project of a basic function affects another project or, because a plurality of functions are associated, one person is assigned to a plurality of projects and some relation occurs among the projects. For example, the conventional WBS and the conventional Gantt chart have an object of scheduling and managing respective projects and do not simultaneously grasp progress statuses of a plurality of projects and a relation among the projects.

The present invention makes it easy to grasp, when a plurality of projects proceed in parallel, progress statuses of the projects and a relation among the projects.

The present invention is implemented as a system explained below. This system is a system for managing a plurality of projects, including: an layout unit laying out, for each project, a project image, which is an image representing that project, in a position on a diagram determined on the basis of a progress status of the project; and a display control unit laying out, using a degree of association between projects obtained on the basis of influence information indicating, for each project, that work of that project is affected by work of another project and resource information indicating resources allocated to the respective projects, an association degree image indicating a degree of association between one project and another project in association with a project image representing the one project and a project image representing the other project on the diagram and causing a display unit to display the diagram on which the images are laid out.

In one embodiment, when the association degree image laid out between the one project image and the other project image is selected, the display control unit causes the display unit to display information concerning work or information concerning resources related between the one project and the other project associated with the association degree image. In one embodiment, the display control unit causes the display unit to display a project image representing a project such that an amount of work of the project and a display form of the project image representing the project correspond to each other and causes the display unit to display an association degree image indicating a degree of association between projects such that the degree of the association between the projects and a display form of the association degree image correspond to each other. In one embodiment, the layout unit lays out, as the project image, on the basis of an amount of work actually completed in a project, an amount of work in progress, and an amount of work not started yet, a project image divided into three regions including a region indicating the actually completed work, a region indicating the work in progress, and a region indicating the work not started yet. Preferably, the system further includes a storing unit storing the influence information and the resource information for each task in the projects.

Further, the present invention is implemented as a system explained below. This system is a system for managing a plurality of projects, including: an elapse value calculating unit calculating, for each project, an elapse value representing a ratio of a period elapsed to the present point in time to a project period from a start date to a completion scheduled date of that project; an amount of executable work calculating unit calculating, for each project, an amount of work executable before the completion scheduled date on the basis of the remaining number of days from the present point in time to the completion scheduled date and information concerning persons in charge assigned to the project; an amount of completed work calculating unit calculating, for each project, an amount of work that should be completed in the present point in time by subtracting the amount of work calculated by the executable amount of work calculating unit from a total amount of work of the project; a progress value calculating unit calculating, for each project, on the basis of an amount of work actually completed at the present point in time and the amount of work calculated by the amount of completed work calculating unit, a progress value representing a progress status of that project; an association degree calculating unit calculating, on the basis of information indicating that work of a project is affected by work of another project and information concerning persons in charge assigned to the project, a degree of association between the projects; a layout unit determining, for each project, on the basis of the progress value calculated by the progress value calculating unit and the elapse value calculated by the elapse value calculating unit, a position where a project image representing that project on a diagram, one axis of which indicates the progress value and the other axis of which indicates the elapse value, and laying out, on the basis of an amount of actually-completed work, an amount of work in progress, and an amount of work not started yet, in the position determined on the diagram, the project image divided into three regions including a region indicating the actually completed work, a region indicating the work in progress, and a region indicating the work not started yet; and a display control unit laying out, on the basis of the degree of association between the projects calculated by the association degree calculating unit, an association degree image indicating a degree of association between one project and another project between a project image representing the one project and a project image representing the other project on the diagram and causing a display unit to display the diagram on which the images are laid out.

Further, the present invention is implemented as a system explained below. This system is a system for managing a plurality of projects, including: a display control unit laying out, for each project, a project image, which is an image representing that project, in a position on a diagram determined on the basis of a progress status of the project, laying out an association degree image indicating a degree of association between one project and another project in association with one project image representing the one project and another project image representing the other project on the diagram, and causing a display unit to display the diagram on which the images are laid out; an input receiving unit receiving an operation input from a user; and an update display unit updating, when receiving an operation input for changing an execution condition of the one project in the input receiving unit, the one project image according to the change of the execution condition, updating, according to a change in the degree of association due to the change of the execution condition, the other project image and the association degree image laid out in association with the one project image and the other project image, and causing the display unit to display the one project image, the other project image, and the association degree image.

In one embodiment, the system further includes a processing unit performing, according to an operation input for changing the execution condition of the one project, processing associated with the operation input, which is processing for changing a component of the one project, and also changing a component of the other project associated with the component of the one project to change the degree of association, and the update display unit updates, according to the processing by the processing unit, the one project image, the other project image, and the association degree image laid out in association with the one project image and the other project image. More preferably, the input receiving unit receives, as the operation input for changing the execution condition, an operation input performed on the diagram with respect to the one project image. Further, preferably, the input receiving unit receives, as the operation input performed on the diagram, an operation input for moving the one project image, and, when the input receiving unit receives the operation input for moving the one project image, the processing unit performs processing for coordinating a person in charge between the one project and the other project. Preferably, the input receiving unit receives, as the operation input performed on the diagram, an operation input for reducing the one project image, and, when the input receiving unit receives the operation input for reducing the one project image, the processing unit performs processing for excluding work in the one project and excluding work in the other project, which is related to the excluded work in the one project.

The present invention is implemented as a system explained below. This system is a system for managing a plurality of projects, including: a progress value calculating unit calculating, for each project, on the basis of an amount of work not completed at the present point in time and an amount of work executable by a completion scheduled date of a project, a progress value representing a progress status of the project; an association degree calculating unit calculating, on the basis of information indicating that work of a project is affected by work of another project and information concerning a person in charge assigned to the project, a degree of association between the projects; a display control unit laying out, for each project, a project image representing a project in a position on a diagram determined according to the progress value calculated by the progress value calculating unit, laying out, on the basis of the degree of association between the projects calculated by the association degree calculating unit, an association degree image indicating a degree of association between one project and another project between a project image representing the one project and a project image representing the other project, and causing a display unit to display the diagram on which the images are laid out; an input receiving unit selecting, on the diagram, one project image representing the one project and the association degree image laid out between the one project image and another project image and further receiving an operation input for moving the one project image; a processing unit performing, when the input receiving unit receives the operation input, processing for performing coordination of a person in charge between the one project and the other project according to a position to which the one project image moves, shifting assignment of the person in charge from the one project to the other project, and reducing an amount of work executable by a completion scheduled date of the one project or processing for shifting the assignment of the person in charge from the other project to the one project and increasing the amount of work executable before the completion scheduled date of the one project; and an update display unit moving, according to the progress value changed according to the processing by the processing unit, the one project image, the other project image, and the association degree image laid out between the one project image and the other project image, which are laid out on the diagram, and updating display contents of the display unit.

The present invention is implemented as a method for managing a plurality of projects, including the steps of; laying out, for each project, a project image, which is an image representing that project, in a position on a diagram determined on the basis of a progress status of the project; calculating a degree of association between projects on the basis of influence information indicating that work of that project is affected by work of another project and resource information indicating resources allocated to the respective projects; and laying out, on the basis of the calculated degree of association between the projects, an association degree image indicating a degree of association between one project and another project in association with a project image representing the one project and a project image representing the other project on the diagram and causing a display unit to display the diagram on which the images are laid out.

Further, the present invention is implemented as a method for managing a plurality of projects, including the steps of: laying out, for each project, a project image, which is an image representing that project, in a position on a diagram determined on the basis of a progress status of the project, laying out an association degree image indicating a degree of association between one project and another project in association with one project image representing the one project and another project image representing the other project of the diagram, and causing a display unit to display the diagram on which the images are laid out; and updating, when receiving an operation input for changing an execution condition of the one project, the one project image according to the change of the execution condition, updating, according to a change in the degree of association due to the change of the execution condition, the other project image and the association degree image laid out in association with the one project image and the other project image, and causing the display unit to display the one project image, the other project image, and the association degree image.

Furthermore, the present invention is also implemented as a computer program in a computer program product for controlling a computer to implement the functions of the system explained above or a program for causing a computer to execute processing corresponding to the steps of the method explained above. This program can be provided by storing it in a magnetic disk, an optical disk, a semiconductor memory, or other recording media and distributing the media, or by delivering it via a network.

According to the present invention, when a plurality of projects proceed in parallel, it is possible to easily grasp progress statuses of the projects and a relation among the projects.

An embodiment of the present invention is explained in detail below with reference to the accompanying drawings.

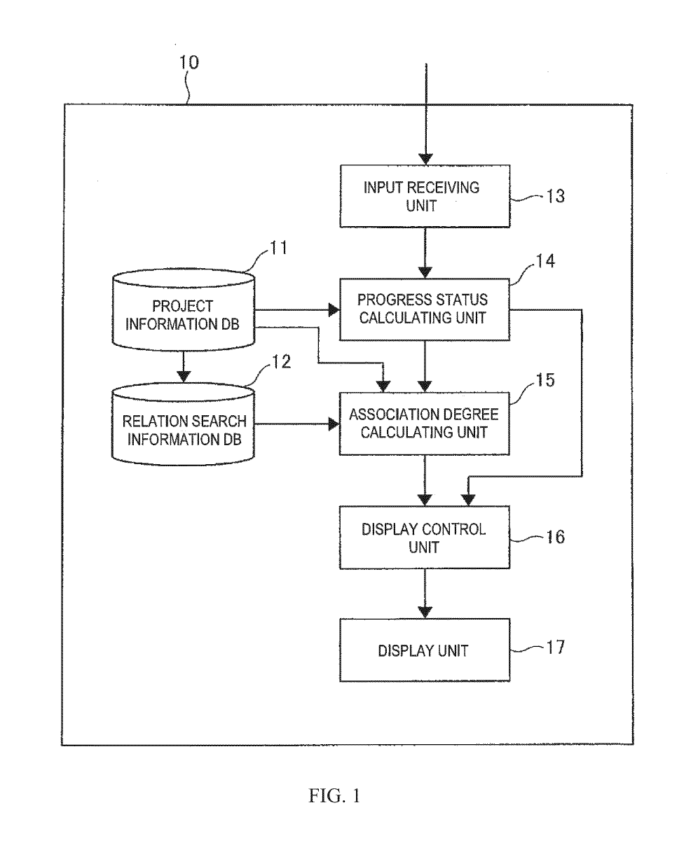

FIG. 1 is a block diagram showing a functional configuration example of the project managing system 10, in accordance with embodiments of the present invention. The project managing system 10 according to this embodiment is a system used for managing various projects such as a project for developing an application. The project managing system 10 stores information concerning a plurality of projects. The project managing system 10 displays information indicating progress statuses of the projects and presents the information to a user. The project managing system 10 presents not only a progress status of a project alone but also information indicating a relation between different projects. Further, the project managing system 10 also presents information indicating, for example, when a condition in executing a project such as assignment of a person in charge (hereinafter referred to as operator) to the project is changed, what kind of influence does the change of the conditions has on the project.

First, a functional configuration of the project managing system 10 according to this embodiment is explained. As shown in FIG. 1, the project managing system 10 includes a project information database (hereinafter referred to as project information DB) 11, a relation search information database (hereinafter referred to as relation search information DB) 12, an input receiving unit 13, a progress status calculating unit 14, an association degree calculating unit 15, a display control unit 16, and a display unit 17.

The project information DB 11 stores information concerning projects. The information concerning projects (hereinafter referred to as project information) is, for example, a start date and a completion scheduled date of a project, a task (work) list in the project, work contents completed in each task, and information concerning resources such as operators and facilities assigned to the project (resource information). In the project information DB 11, these kinds of information are stored for each project.

The project information also includes information indicating that a task of a project is affected by another project (influence information). For example, when functions developed by the respective tasks are related and two tasks are executed in parallel while work content of one task and work content of the other task are involved in each other, a task of one project is affected by another project. For example, when there is a dependency relation between the tasks and the other task is started on the basis of an execution result of the one task, the task of the project is affected by the other project. Further, for example, when the other task is executed using a facility environment used in the one task, the task of the project may be regarded as being affected by the other project. Information indicating such influence between the tasks is also stored in the project information DB 11.

Such project information is updated, for example, when work in a day ends, by the operators or the like according to progress statuses of the projects such that the project information is always in the latest status. Details of the project information are explained below.

The relation search information DB 12 serving as an example of the storing unit stores information used for searching for a relation between projects (hereinafter referred to as relation search information). Specifically, information indicating a relation between tasks and resources and information indicating influence between the tasks are sorted out and stored for each task. The information indicating the relation between the tasks and the resources is, for example, information indicating which operators are assigned to tasks in a project. The information indicating the influence among the tasks is information indicating that a task is affected by another task as explained above. The relation search information is generated on the basis of the project information stored in the project information DB 11. The relation search information DB 12 updates the relation search information at any time to reflect contents of the latest project information. Specifically, the relation search information DB 12 updates the relation search information on the basis of the project information of the project information DB 11, for example, every time the project information is updated, periodically, automatically, or according to operation by the user. Details of the relation search information are explained below.

The input receiving unit 13 serving as an example of the input receiving unit receives an operation input from the user. For example, the input receiving unit 13 receives, from the user, an operation input for instructing display of a progress status of a project. The input receiving unit 13 receives, from the user, an operation input for, in displayed information, for example, changing placement of the operators for the project or changing execution conditions of the project for excluding a task in the project. Such an operation input by the user is performed by, for example, the user operating a mouse or a keyboard.

The progress status calculating unit 14 calculates progress statuses of the projects on the basis of the project information stored in the project information DB 11. When the input receiving unit 13 receives an operation input for instructing display of progress statuses of projects, the progress status calculating unit 14 acquires, from the project information DB 11, project information concerning the projects, the progress statuses of which are instructed to be displayed. The progress status calculating unit 14 calculates progress statuses on the basis of the acquired project information of the projects. Details of a procedure in which the progress status calculating unit 14 calculates progress statuses are explained below. In this embodiment, the progress status calculating unit 14 is used as an example of the elapse value calculating unit, the executable amount of work calculating unit, the amount of completed work calculating unit, the progress value calculating unit, and the processing unit.

Further, when the input receiving unit 13 receives an operation input for changing execution conditions of a project, the progress status calculating unit 14 calculates a progress status of the project again according to the change of the execution conditions. The progress status calculating unit 14 calculates progress statuses again concerning not only the project for which the execution conditions are changed but also another project related to the project. Additionally, the progress status calculating unit 14 performs, according to the operation input for changing the execution conditions of the project, processing associated with the operation input, which is processing for changing components of the project such as operators and tasks in the project, and also changes components of the other project related to the components.

The association degree calculating unit 15 serving as an example of the association degree calculating unit searches for, concerning the projects, the progress statuses of which are instructed to be displayed, a relation between the projects on the basis of the relation search information of the relation search information DB 12. When obtaining a search result concerning the relation between the projects, the association degree calculating unit 15 calculates a degree of association between the projects on the basis of the project information stored in the project information DB 11. The association degree calculating unit 15 calculates the degree of association between the projects using information indicating that tasks of a project affect another project and information concerning resources such as operators and facilities assigned to the project. When the input receiving unit 13 receives an operation input for changing execution conditions of projects, the association degree calculating unit 15 calculates a degree of association between the projects again according to the change of the execution conditions. In the following explanation, the degree of association between the projects is simply referred to as association degree.

The display control unit 16 lays out images representing the projects (hereinafter referred to as project images) on a graph for each project on the basis of the progress statuses calculated by the progress status calculating unit 14. The display control unit 16 lays out the project images in positions on the graph determined by the progress statuses. In the following explanation, the graph on which the project images are laid out is referred to as, in particular, progress status graph. The display control unit 16 lays out, on the basis of the association degree calculated by the association degree calculating unit 15, an image indicating the degree of association between the projects (hereinafter referred to as association degree image) on the progress status graph. The display control unit 16 lays out an association degree image indicating an association degree between one project and another project in association with a project image representing the one project and a project image representing the other project in the progress status graph. The display control unit 16 lays out, concerning the projects in the progress status graph, association degree images in association with the projects between the projects and the other projects and causes the display unit 17 to display the progress status graph.

When the input receiving unit 13 receives an operation input for changing an execution condition of a project, the display control unit 16 updates and displays the progress status graph according to the change of the execution condition. The display control unit 16 changes, on the basis of the progress statuses calculated by the progress status calculating unit 14, the positions where the project images are laid out and associates the association degree image again with the project images, the positions of which are changed, on the basis of the association degree calculated by the association degree calculating unit 15. In this way, the display control unit 16 updates the images and displays the progress status graph. In this embodiment, the display control unit 16 is used as an example of the layout unit, the display control unit, and the update display unit.

Note that, in causing the display unit 17 to display the various images on a screen of the display unit 17, the display control unit 16 configures the screen of the display unit 17 as a plane configured by coordinate axes and determines display positions on the basis of coordinates of the various images. The display control unit 16 causes the display unit 17 to display, for example, the project images, the arrangement positions of which are changed, on the basis of coordinates after the change.

The display unit 17 is a display device such as a liquid crystal display and displays various kinds of information on a display screen under the control by the display control unit 16.

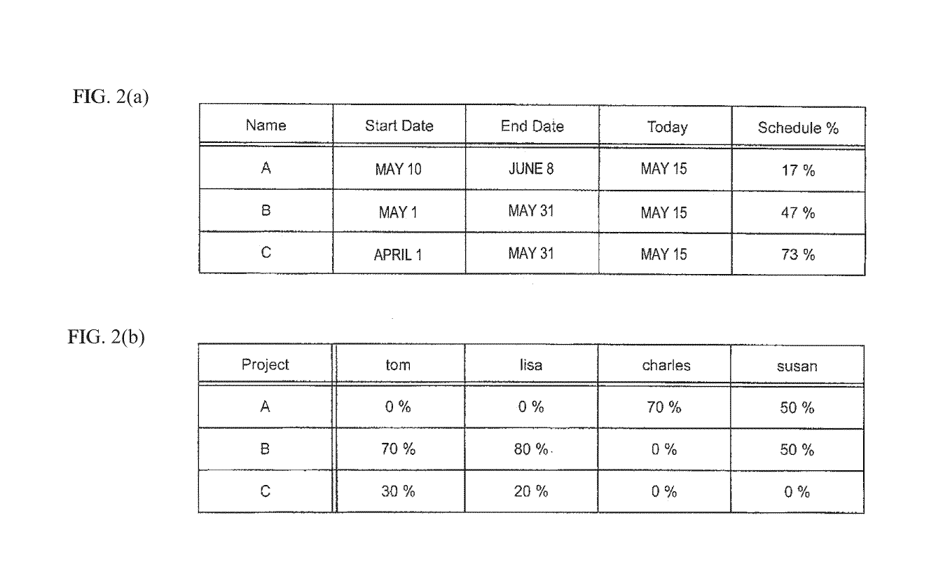

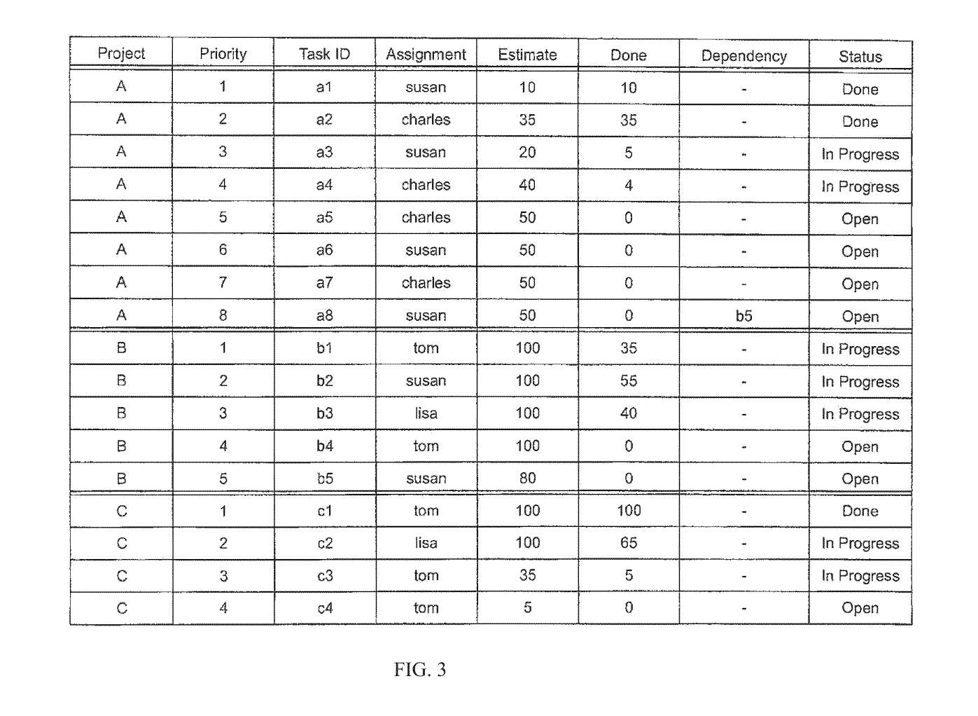

Next, the project information stored in the project information DB 11 is explained. FIGS. 2(a) and 2(b) and FIG. 3 are diagrams showing examples of the project information. Project information concerning various projects is stored in the project information DB 11. Here, project information concerning three projects, i.e., projects A to C currently in progress is explained.

FIG. 2(a) is a diagram showing an example of a project list, in accordance with embodiments of the present invention. “Name” indicates project names, “Start Date” indicates start dates of projects, “End Date” indicates completion scheduled dates, and “Today” indicates a date of the day. “Schedule %” indicates percent complete which are ratios of periods elapsed to the present point in time in a period from the start date of the project before the completion scheduled date of the project (hereinafter referred to as project period). In other words, a project's schedule percent is defined as a percent equivalent of a ratio of the project's elapsed time at the present time to the project's total allocated time

In the example shown in FIG. 2(a), for example, concerning a project with a project name “A” (hereinafter referred to as project A; similarly, the other projects are referred to as project B and project C), it is indicated that the start date of the project is May 10 and the completion scheduled date of the project is June 8. The day is May 15. It is calculated that a period of 17% has elapsed to the day in the project period of May 10 to June 8.

FIG. 2(b) is a diagram showing an example of allocations of amounts of work to operators for projects, in accordance with embodiments of the present invention. “Project” indicates projects (project names) and “tom”, “lisa”, “charles”, and “susan” indicate names of the operators. The figure represents at which ratios the operators are in charge of the respective projects.

In the example shown in FIG. 2(b), the operator with the operator (i.e., user name or worker name) name “tom” (hereinafter simply referred to as tom; similarly, the other operators (i.e., users or workers) are simply referred to as lisa, charles, and susan) allocates 70% of an own work time to a project B and allocates 30% of the work time to a project C. Further, tom is not in charge of a project A. Similarly, charles is not in charge of the project B and the project C and allocates 70% of an own work time to the project A. Further, charles allocates remaining 30% of the own work time to projects other than the projects A to C. For each operator, the summation of the percent work time allocations to projects A, B and C is 100%.

FIG. 3 is a diagram showing an example of a list of tasks in the projects, in accordance with embodiments of the present invention. “Project” indicates projects (project names), “Priority” indicates priority levels of tasks to be executed, “Task ID” indicates identifiers allocated to the tasks, and “Assignment” indicates the operators assigned to the tasks. “Estimate” indicates total amount of work of the task in terms of work times as times required before completion of the tasks and “Done” indicates amount of work executed so far in terms of work times. Further, “Dependency” indicates other tasks at dependency destinations having dependency relations (e.g., task a8 depends on task b5) and “Status” indicates processing statuses of the tasks.

In the example shown in FIG. 3, there are eight tasks in total with “Task ID” a1 to a8 in the project A. There are five tasks in total with “Task ID” b1 to b5 in the project B. There are four tasks in total with “Task ID” c1 to c4 in the project C. For example, in the project A, priority levels are set for the eight tasks in order. Tasks with “Priority” indicating 1 have the highest priority level. Therefore, the tasks are executed in order from the task a1 having the highest priority level. The task a1 is assigned to susan. “Estimate” indicates that work for 10 hours is necessary before the completion of the task. On the other hand, since “10” is recorded in “Done” of the task a1, the work for 10 hours has been completed. That is, the task a1 is considered to be entirely completed. Therefore, in “Status” of the task a1, “Done” indicating that the task is completed is recorded.

For example, the task a3 is a task executed the third among the tasks of the project A because “Priority” indicates 3. The task a3 is assigned to susan. “Estimate” indicates that work for 20 hours is necessary before the completion of the task. On the other hand, since “5” is recorded in “Done” of the task a3, work for 5 hours has been completed at the present point in time in the work for 20 hours. Therefore, in “Status” of the task a3, “In Progress” indicating that the task is in progress is recorded.

Further, for example, the task a8 is a task executed the eighth among the tasks of the project A because “Priority” indicates 8. The task a8 is assigned to susan. “Estimate” indicates that work for 50 hours is necessary before the completion of the work. On the other hand, since “0” is recorded in “Done” of the task a8, the task a8 has not been started yet. Therefore, in “Status” of the task a8, “Open” indicating that the task has not been started yet is recorded.

In the task a8, “b5” is recorded in “Dependency”. The task a8 depends on the task b5, “Task ID” of which indicates “b5”, in the project B. On the other hand, in the task b5, nothing is recorded in “Dependency”. Therefore, the task b5 is executed without being affected by the task a8. However, the task a8 depends on the task b5. For example, a situation is conceivable in which the task a8 is executed using a function developed by the task b5.

Next, the relation search information stored in the relation search information DB 12 is explained.

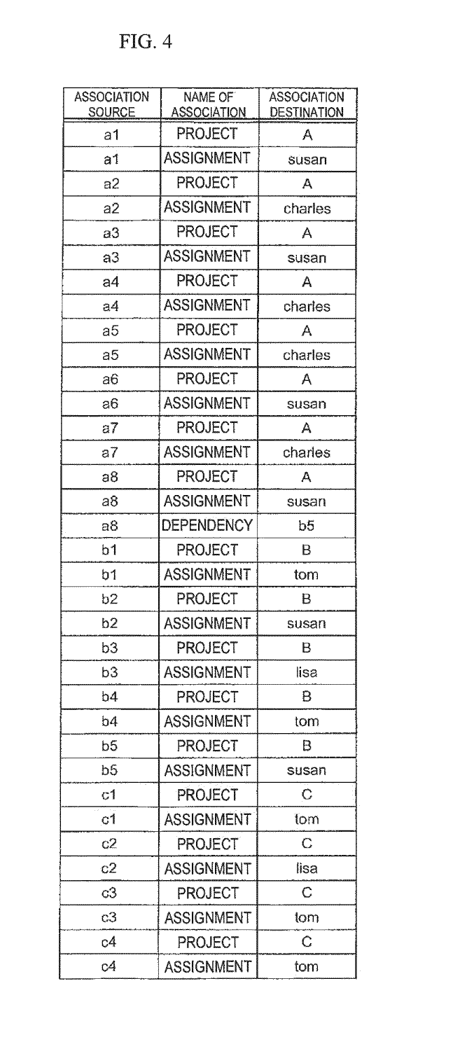

FIG. 4 is a diagram showing an example of the relation search information, in accordance with embodiments of the present invention. In the relation search information DB 12, relation search information concerning various projects is stored. Here, relation search information concerning the three projects, i.e., the projects A to C currently in progress is explained.

“Association source” indicates identifiers (Task IDs of FIG. 3) allocated to tasks and “name of association” indicates what types “association destination” is. For example, when “name of association” is “Project”, “association destination” indicates a project (a project name) to which a task at an association source belongs. When “name of association” is “assignment”, “association destination” indicates an operator assigned to the task at the association source. Further, when “name of association” is “dependency”, “association destination” indicates another task on which the task at the association source depends.

In the example shown in FIG. 4, information corresponding to “project” and “assignment” is shown concerning the tasks of the projects A to C. For example, when “association source” is a1, the project A to which the task a1 belongs is shown in “project” and susan in charge of the task a1 is recorded in “assignment”. For example, concerning the task a8, in the item of “name of association”, “dependency” is provided in addition to “project” and “assignment” and b5 is recorded in “association destination”. That is, it is indicated that the task a8 depends on the task b5.

In this way, in the relation search information, information concerning a project, information concerning an operator, and information concerning other related tasks are sorted out and recorded for each task. Therefore, when searching for a relation between projects, by using the relation search information, the association degree calculating unit 15 can easily search for the relation between the projects, that is, a relation between a task and an operator and a relation between a task and another task. Additionally, for example, compared with a configuration for searching for a relation among tasks using only the project information, which is source data of the relation search information, since the association degree calculating unit 15 uses the relation search information, the search among the projects is performed at high speed. In particular, the effect of using the relation search information is considered to be higher as the number of kinds of the project information stored in the project information DB 11 increases. Note that the relation search information is not limited to the configuration shown in FIG. 4. For example, information concerning a facility in use may be recorded for each task.

Next, processing in which the project managing system 10 generates and displays the progress status graph is explained.

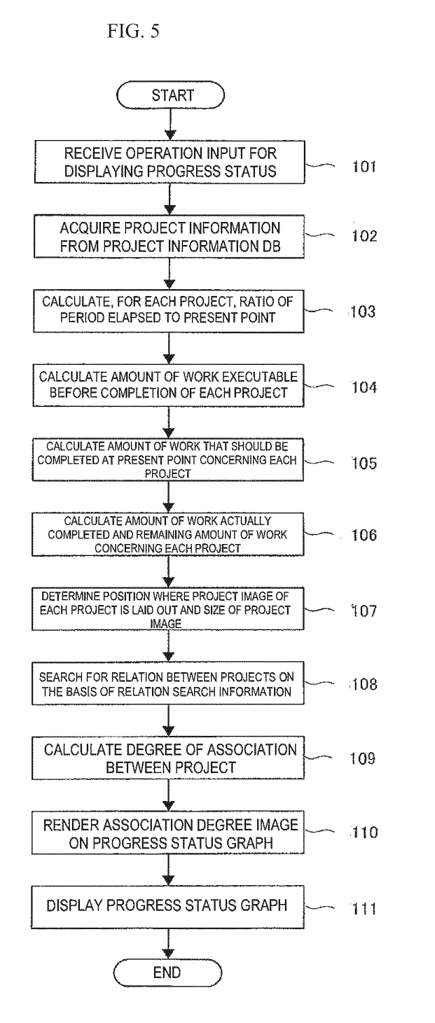

FIG. 5 is a flowchart showing an example of a processing procedure for generating and displaying the progress status graph, in accordance with embodiments of the present invention. In the procedure shown in FIG. 5, the processing is explained assuming that the projects A to C are selected by the user and an operation input for displaying progress statuses of the projects A to C is performed.

First, the input receiving unit 13 receives an operation input for displaying progress statuses of projects (step 101). Subsequently, the progress status calculating unit 14 acquires, from the project information DB 11, project information concerning the projects designated to be displayed (step 102). In the operation input in step 101, the operation is input to display progress statuses of the projects A to C. Therefore, the progress status calculating unit 14 acquires project information of the projects A to C from the project information DB 11. In the procedure shown in FIG. 5, it is assumed that the progress status calculating unit 14 acquires the project information shown in FIG. 2 and FIG. 3 as the project information of the projects A to C.

Subsequently, the progress status calculating unit 14 calculates, on the basis of the acquired project information of the projects, for each project, a ratio of a period elapsed to the present point in time to a project period from a start date to a completion date of the project (step 103). Here, the progress status calculating unit 14 calculates a value of “Schedule %” in the project information shown in FIG. 2(a).

Subsequently, the progress status calculating unit 14 calculates information indicating an amount of work executable before the completion of each project in the present assignment of the operators (step 104). Here, the progress status calculating unit 14 calculates, on the basis of the project information shown in FIG. 2(a), for each project, the remaining number of days from the present point in time until a project completion scheduled day. The progress status calculating unit 14 multiplies together the calculated remaining number of days and allocations of amounts of work to the operators assigned to the project to calculate, for each project, amounts of work executable by the operators.

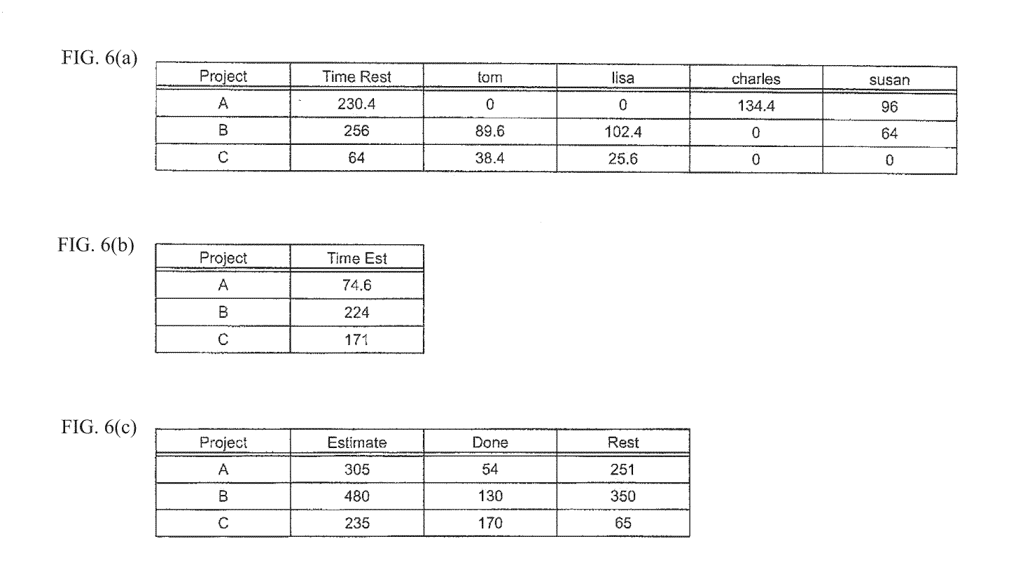

FIG. 6(a) is a diagram showing an example of amounts of work executable by the operators before the completion of the projects, in accordance with embodiments of the present invention. In the example shown in FIG. 6(a), amounts of remaining work for the projects by the four operators, tom, lisa, charles, and susan are shown. For each project, “Time Rest” indicates a total amount of remaining work of all the operators combined.

For example, from the project information shown in FIG. 2(a), concerning the project A, a project completion scheduled day is June 8 and the present date and time is May 15. Therefore, the remaining number of days is 24 days. From the project information shown in FIG. 2(b), an allocation to charles for the project A is 70%. Here, for example, when a work time of the operators in one day is specified as 8 hours, an amount of work executable by charles before the project completion for the project A is calculated by 24 days×8 hours×70% in terms of a work time, that is, 134.4 hours. Therefore, in the example shown in FIG. 6(a), it is indicated that a work time of charles is “134.4” concerning the project A. In the same procedure, a work time of susan is calculated as “96” concerning the project A. Work times of tom and lisa are “0” because tom and lisa are not in charge of the project A. When amounts of work of the four operators are totaled, “230.4” is obtained. Amounts of work can be calculated concerning the project B and the project C by the same procedure.

Subsequently, the progress status calculating unit 14 calculates an amount of work that should be completed at the present point in time concerning each project (step 105). Here, the progress status calculating unit 14 subtracts, concerning the projects, the amounts of work executable before the project completion from the total amounts of work to calculate the amounts of work that should be completed at the present point in time.

FIG. 6(b) is a diagram showing an example of the amounts of work that should be completed at the present point in time concerning the projects, in accordance with embodiments of the present invention. In the example shown in the figure, “Time Est” indicates the amounts of work that should be completed at the present point in time.

For example, from the project information shown in FIG. 3, an entire amount of work of the project A is calculated as “305” by totaling amounts of work of the tasks. An amount of work executable before the project completion for the project A is “230.4” as calculated in step 104. Therefore, an amount of work that should be completed at the present point in time concerning the project A is calculated as “74.6” by subtracting “230.4” from “305”. Therefore, in the example shown in FIG. 6(b), it is indicated that “Time Est” is “74.6” concerning the project A. “Time Est” is calculated by the same procedure concerning the project B and the project C.

Subsequently, the progress status calculating unit 14 calculates an amount of work actually completed and a remaining amount of work concerning each project (step 106). Here, the progress status calculating unit 14 subtracts, concerning the projects, the amounts of actually-completed work from the entire amounts of work and calculates the remaining amounts of work.

FIG. 6(c) is a diagram showing an example of the amounts of work actually completed concerning the projects and the remaining amounts of work, in accordance with embodiments of the present invention. In the example shown in the figure, “Estimate” indicates the entire amounts of work, “Done” indicates the amounts of actually-completed work, and “Rest” indicates the remaining amounts of work.

For example, the entire amount of work of the project A is “305” as calculated in step 105. An amount of work actually completed concerning the project A is calculated as “54” by totaling values recorded in “Done” from the project information shown in FIG. 3. The remaining amount of work of the project A is calculated as “251” by subtracting “54” from “305”. Therefore, in the example shown in FIG. 6(c), concerning the project A, it is indicated that “Estimate” is “305”, “Done” is “54”, and “Rest” is “251”. Entire amounts of work, amounts of actually-completed work, and remaining amounts of work are calculated by the same procedure concerning the project B and the project C.

Subsequently, the progress status calculating unit 14 determines a position where a project image of each project is laid out and a size of the project image (step 107).

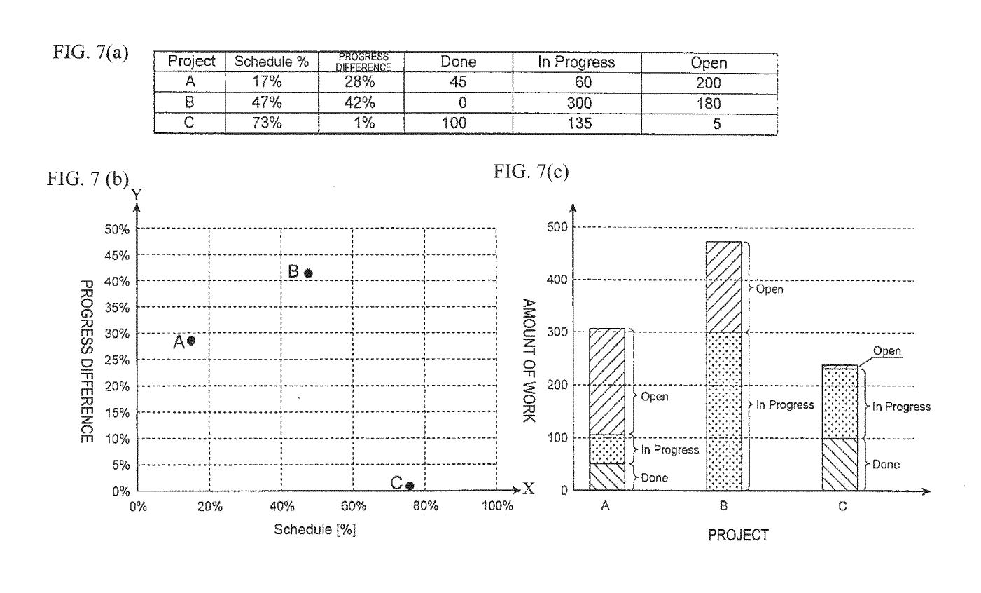

FIG. 7(a) is a diagram showing examples of values of positions where the project images of the projects are laid out and the sizes of the project images, in accordance with embodiments of the present invention. FIGS. 7(b) and 7(c) are diagrams showing examples of graphs generated on the basis of the values shown in FIG. 7(a), in accordance with embodiments of the present invention.

Concerning the values shown in FIG. 7(a), “Schedule %” is “Schedule %” shown in FIG. 2(a), that is, it indicates a ratio of a period elapsed to the present point in time to a project period and represents a percent of time elapsed relative to the total time allocated to the project. Therefore, in “Schedule %” shown in FIG. 7(a), “17%”, “47%”, and “73%” are recorded respectively concerning the projects A to C. “Progress difference” is a measure of lack of progress of a project currently.

The progress difference is a value obtained by dividing, for each project, an “amount of actually-completed work” by an “amount of work that should be completed at the present point in time”, subtracting a value obtained by the division from 1, and indicating a value obtained by the subtraction in percentage. In this embodiment, the progress difference is used as an example of the progress value. In other words, a project's progress difference is defined as a percent equivalent of one minus a ratio of an amount of actually-completed work by the project at the present time to an amount of work that should be completed by the project at the present time. The total amount of work that should be completed by the project at the present time is defined as the total amount of work for the project minus the total amount of work scheduled to be subsequently done for the project going forward in time from the present time.

Here, as the “amount of actually-completed work” is larger, the progress of a project is considered to be better. Therefore, as the value obtained by dividing the “amount of actually-completed work” by the “amount of work that should be completed at the present point in time” is larger, that is, as the progress difference is smaller, the project proceeds as scheduled more and the progress is better. As the progress difference is larger, the project is further behind the schedule and the progress is worse. Further, when the project proceeds earlier than the schedule, the “amount of actually-completed work” is larger than the “amount of work that should be completed at the present point in time”. In this case, the value obtained by dividing the “amount of actually-completed work” by the “amount of work that should be completed at the present point in time” is larger than 1. However, the progress difference is represented by “0%”.

For example, in the project A, from the value of “Done” shown in FIG. 6(c), the amount of actually-completed work is “54”. From the value of “Time Est” shown in FIG. 6(b), the amount of work that should be completed at the present point in time is “74.6”. Therefore, a progress difference of the project A is calculated by 1−(54/74.6) as “28%”. Progress differences are calculated by the same procedure in the project B and the project C. The progress differences are respectively “42%” and “1%”. Therefore, in “progress difference” shown in FIG. 7(a), “28%”, “42%”, and “1%” are respectively recorded concerning the projects A to C. Additionally, concerning the progress degrees of the projects, if the projects are laid out in order from the project with the best progress, the project C, the project A, and the project B are laid out in this order. In other words, progresses are worse in the order of the project B, the project A, and the project C.

Concerning the values shown in FIG. 7(a), “Done” indicates amounts of work of tasks actually completed in the projects, that is, amounts of work of tasks, processing statuses of which are “Done”. “In Progress” indicates amounts of work of tasks in progress in the projects, that is, amounts of work of tasks, processing statuses of which are “In Progress”. “Open” indicates amounts of work of tasks not started yet in the projects, that is, amounts of work of tasks, processing statuses of which are “Open”.

For example, from the project information shown in FIG. 3, tasks of “Done” in the project A are “a1” and “a2”. A total of amounts of work of the tasks is “45”. Tasks of “In Progress” in the project A are “a3” and “a4”. A total of amounts of work of the tasks is “60”. Further, tasks of “Open” in the project A are “a5”, “a6”, “a7” and “a8”. A total of amounts of work of the tasks is “200”. Therefore, in “Done”, “In Progress”, and “Open” of the project A shown in FIG. 7(a), “45”, “60”, and “200” are respectively recorded. Totals of amounts of work are calculated by the same procedure concerning the project B and the project C. The display control unit 16 determines the sizes of the project images on the basis of the values of the amounts of work and lays out, on the progress status graph, the project images divided into three regions, i.e., a region indicating actually-completed work, a region indicating work in progress, and a region indicating work not started yet.

FIGS. 7(b) and 7(c) are graphs generated on the basis of the values shown in FIG. 7(a). First, in the graph shown in FIG. 7(b), the ordinate along the Y axis represents “progress difference” at the present time and the abscissa along the X axis represents “Schedule %” at the present time. The X and Y axes are mutually orthogonal. “Progress difference” shown in FIG. 7(a) corresponds to values of the ordinate and “Schedule %” shown in FIG. 7(a) corresponds to values of the abscissa. Positions where the project images are laid out are indicated by points of the projects. In the graph shown in FIG. 7(c), the ordinate represents an “amount of work” and the abscissa represents the projects. “Done”, “In Progress”, and “Open” shown in FIG. 7(a) are values of the ordinate. Amounts of work of the projects A to C are indicated for each of “Done”, “In Progress”, and “Open”.

Subsequently, the association degree calculating unit 15 searches for a relation between projects on the basis of the relation search information stored in the relation search information DB 12 (step 108). For example, when searching for a relation between the project B and the project C, first, the association degree calculating unit 15 acquires, from the relation search information DB 12, relation search information concerning the project B and the project C. The relation search information acquired here is relation search information concerning the project B and the project C among the relation search information shown in FIG. 4. Subsequently, the association degree calculating unit 15 searches for operators who are in charge of both of the project B and the project C. The association degree calculating unit 15 searches whether any relation is present between tasks in the project B and tasks in the project C.

In the example shown in FIG. 4, a search result is obtained that indicates that tom and lisa correspond to the operators who are in charge of both of the project B and the project C. Further, a search result is obtained that indicates that a dependency relation is absent between the tasks in the project B and the tasks in the project C. When obtaining information concerning the found operators (in the example shown in FIG. 4, tom and lisa), the association degree calculating unit 15 calculates, on the basis of the project information of the project information DB 11, an association degree between the project B and the project C (step 109). For example, the association degree calculating unit 15 totals the remaining amounts of work of the tasks, of which tom and lisa are in charge in the project B and the project C, and sets the totaled amount of work as an association degree (i.e., a degree of association).

For example, from the project information shown in FIG. 3, tasks, of which tom is in charge in the project B, are “b1” and “b4” and tasks, of which tom is in charge in the project C, are “c1”, “c3”, and “c4”. The remaining amount of work of the task b1 is calculated as “65” by subtracting the amount of completed work “35” from the entire amount of work “100”. Similarly, the remaining amount of work of the task b4 is calculated as “100”. The remaining amounts of work of the task c1, the task c3, and the task c4 are respectively “0”, “30”, and “5”. A total of all of the remaining amounts of work of these tasks is calculated as “200”. A task, of which lisa is in charge in the project B, is the task b3 and a task, of which lisa is in charge in the project C, is the task c2. A total of the remaining amounts of work of these tasks is calculated as “95”. Therefore, an association degree between the project B and the project C is calculated as “295” by adding up “200” and “95”.

An association degree between the project A and the project B is calculated as “240” by the same procedure. Since the task a8 of the project A depends on the task b5 of the project B, the association degree calculating unit 15 may further add a value to the association degree between the project A and the project B taking into account a relation between the tasks. Concerning the project A and the project C, since an operator in charge of both of the project A and the project C is absent, an association degree is “0”.

Subsequently, the display control unit 16 renders, on the basis of the association degree calculated by the association degree calculating unit 15, an association degree image indicating the association degree between the projects on a progress status graph (step 110).

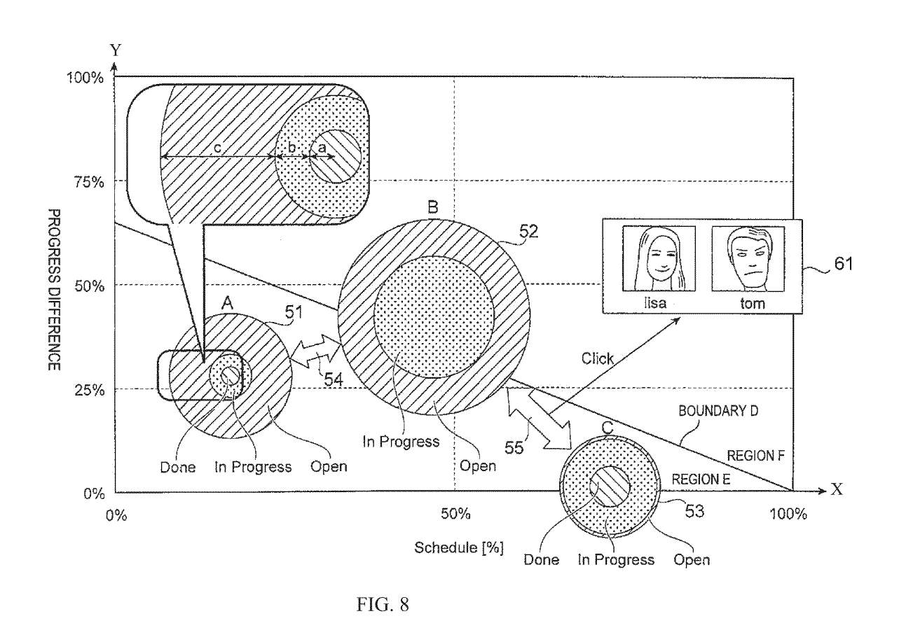

FIG. 8 is a diagram showing an example of the progress status graph displayed on a display screen of a display unit 17 (see FIG. 1), in accordance with embodiments of the present invention. In the progress status graph shown in FIG. 8, as in the graph shown in FIG. 7(b), the ordinate along the Y axis represents “progress difference” and the abscissa along the X axis represents “Schedule %”. The graph is divided into two regions, i.e., a region E and a region F by a boundary D. The region E indicates a region where the progress of a project is determined as satisfactory. The region F indicates a region where a project is highly likely to be not completed in a completion scheduled day and the progress of the project is determined as bad. The arrangement of the boundary D, the region E, and the region F is determined by rules set in advance. Further, in the example shown in FIG. 8, project images are represented as images of circles A, B, and C whose radial centers are explicitly shown in FIG. 7(b) as “A”, “B”, and “C”, respectively. The position on the graph of FIG. 8 of the radial center of each circle denotes a (X,Y) value for the project represented by each circle.

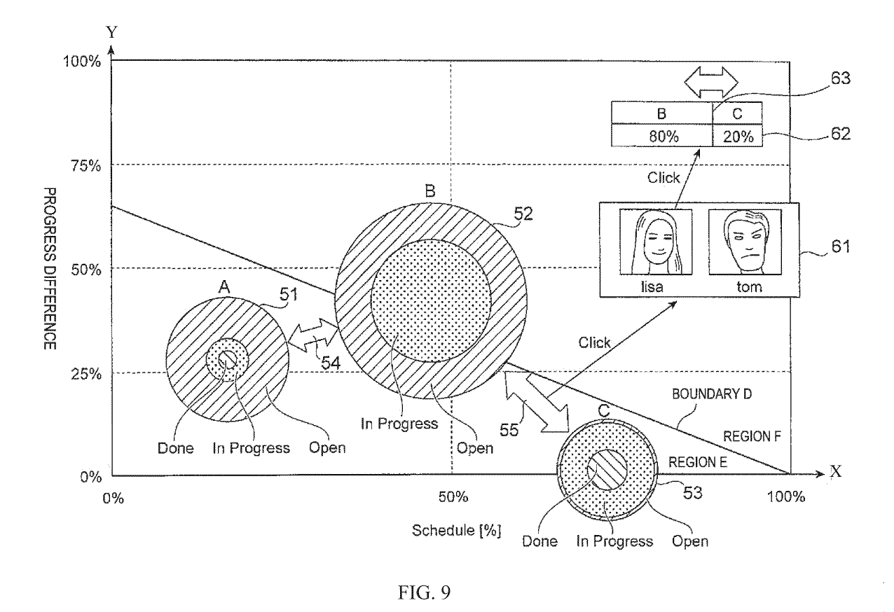

FIG. 8 illustrates an embodiment in which the boundary D is a straight line between a first point and a second point. The first point is Schedule=100% and Progress Difference=0%. The second point is Schedule=0% and Progress Difference=a specified or predetermined threshold above which the progress of a project is considered unsatisfactory at Schedule=0%. In FIG. 9, the specified or predetermined threshold is 65%.

The project images are laid out in the positions where the project images are laid out shown in FIG. 7(b). A project image 51 represents the project A, a project image 52 represents the project B, and a project image 53 represents the project C. The project images are divided into regions indicating amounts of work of tasks, i.e., “Done”, “In Progress”, and “Open”. The widths of the regions are equivalent to the amounts of work of the tasks. Different patterns and colors added to the regions of “Done”, “In Progress”, and “Open” of the project images respectively correspond to those added to the regions of “Done”, “In Progress”, and “Open” shown in FIG. 7(c).

For example, in the project A, as shown in FIG. 7(a), the amounts of work of “Done”, “In Progress”, and “Open” are “45”, “60”, and “200”. The respective work amounts are converted into lengths of the widths of the regions of the project images on the basis of standards set in advance. In the example shown in FIG. 8, widths (i.e., radial thickness) corresponding to “45”, “60”, and “200” are calculated as width “a”, width “b”, and width “c” in the project image 51. In this way, for the projects, the amounts of work of the projects and the display forms of the project images are associated to render the project images. In the example shown in FIG. 8, in the project image 51 and the project image 53, since the centers of the circles are present in the region E, the progress is determined as satisfactory. On the other hand, since the center of the project image 52 is present in the region F, the progress is determined as bad concerning the project B.

In the example shown in FIG. 8, association degree images are represented as images of arrows. An arrow image 54 represents an association degree between the project A and the project B. The arrow image 54 is disposed between, and points to, the circles representing projects A and B. An arrow image 55 represents an association degree between the project B and the project C. The arrow image 55 is disposed between, and points to, the circles representing projects B and C. The association degrees are converted into thicknesses of the arrows according to standards set in advance. In one embodiment, the ratio of the thickness of arrow 55 to the thickness of arrow 54 is equal to the ratio of the association degree between the project B and the project C to the association degree between the project A and the project B. As values of the association degrees are larger, the arrows are rendered thicker. For example, the association degree between the project A and the project B is “240” and the association degree between the project B and the project C is “295”. Therefore, the arrow image 55 is rendered thicker than the arrow image 54. Since the association degree between the project A and the project B is “0” and there is no relation between the projects, an arrow is not rendered between the projects. The association degree is not limited to the configuration represented by the image of the arrow and may be any configuration as long as the projects are laid out in association with each other. The association degree is not limited to the configuration for changing the thickness of the arrow according to the association degree. For example, the color and the pattern of the arrow may be changed according to the association degree. In this way, for the projects, the degree of association with another project and the display form of the association degree image are associated to render the association degree image.

The display control unit 16 displays, on the display unit 17, the progress status graph on which the project images of the projects and the association degree image indicating the association degree between the projects are rendered (i.e., the graph shown in FIG. 8) (step 111). The display control unit 16 may also display, on the display unit 17, the graphs shown in FIGS. 7(b) and 7(c) as graphs indicating progress statuses of the projects. Then, this processing flow ends.

In the graph shown in FIG. 8, the display control unit 16 displays, for the projects, the arrow indicating the relation between the projects. However, for example, at timing when the user selects a circle corresponding to a project on the graph, the display control unit 16 may display an arrow indicating a relation with the selected project. In this case, the display control unit 16 may display, as the arrow to be displayed, only an arrow indicating a direct relation with the selected project or may display arrows indicating direct and indirect relations. When only the arrow indicating the direct relation is displayed, in the example shown in FIG. 8, when the user selects a circle corresponding to the project A, an arrow between the project A and the project B is displayed. When the arrows indicating the direct and indirect relations are displayed, in the example shown in FIG. 8, when the user selects the circle corresponding to the project A, as the arrow indicating the direct relation with the project A, the arrow between the project A and the project B is displayed. As the arrow indicating the indirect relation with the project A, an arrow between the project B related to the project A and the project C is displayed.

Further, when the user selects an arrow on the progress status graph shown in FIG. 8, information concerning the arrow, that is, detailed information concerning a relation between projects may be displayed. For example, in the example shown in FIG. 8, when the user clicks and selects the arrow between the project B and the project C, a list 61 of operators in charge of both of the projects is displayed. Further, for example, when the user selects an operator in the displayed list 61, tasks of the project A and the project B assigned to the selected operator are displayed as a list. In the displayed task list, as in the project information shown in FIG. 3, information indicating the influence between the tasks may be included.

The processing for displaying the progress status graph is explained according to the procedure shown in FIG. 5. However, the processing for displaying the progress status graph is not limited to such a configuration. For example, the degree of the progress is indicated by the progress difference calculated on the basis of the “amount of actually-completed work” and the “amount of work that should be completed at the present point in time”. However, as the progress difference, a value calculated by another calculation may be used. For example, for each project, a value calculated on the basis of the “amount of work not completed at the present point in time” and an “amount of work executable before the completion scheduled day of the project” may be used as the progress difference.

The displayed graph is not limited to the configurations shown in FIGS. 7(b) and 7(c) and FIG. 8 either. For example, in the example shown in FIG. 8, the size of the project image, as measured by project radius (i.e., outer radius of “Open”) is determined by the amounts of work of the tasks. However, the size of the project image may be determined on the basis of the remaining amount of work. Further, the color and the pattern of the project image and the amounts of work of the tasks may be associated rather than associating the size of the project image and the amounts of work of the tasks. In this case, for example, it is conceivable to darken the color of the project image when the amounts of work increase. Further, as indexes for generating the graphs shown in FIG. 7(b) and FIG. 8, the progress difference is used for the ordinate and Schedule % is used for the abscissa. However, any indexes may be used as long as the indexes are indexes for indicating the progresses of the projects and the relation between the projects.

Next, processing for changing a displayed progress status graph to change execution conditions of a project according to operation by the user is explained. For example, it is conceivable that, in order to complete a project as scheduled, the user changes placement of operators for the project and change tasks in the project to change execution conditions of the project. When performing such a change, if the user can check how a status of the project including related another project changes, the user can easily determine how a schedule should be changed.

Therefore, in this embodiment, when the user makes various changes on the progress status graph, the project managing system 10 displays how statuses of the projects change. That is, the project managing system 10 displays, when execution conditions of a project are changed, how a status of the project changes. Further, the project managing system 10 displays, when the execution conditions of the project are changed, according to a change of an association degree between the project and another project, how the other project and the association degree change. Here, the project managing system 10 only has to display what kind of influence occurs when the execution conditions are changed by the user. The project managing system 10 does not have to actually update values of databases such as the project information DB 11. In the following explanation, operation performed by the user is explained with reference to a specific example.

First, an example is explained in which allocations of amounts of work in the operators are changed according to operation by the user. In this example, the input receiving unit 13 receives an operation input for selecting, as an operation target, an association degree image associated with project images. The display control unit 16 displays, on the basis of the operation input, a list of operators in charge of both projects associated with the selected association degree image. When the input receiving unit 13 receives an operation input for selecting an operator in the list, the display control unit 16 displays an allocation table indicating allocations of an amount of work in the selected operator. The user moves the slider on the allocation table, whereby the allocations of the amount work are changed.

FIG. 9 is a diagram showing an example of a progress status graph displayed when allocations of amounts of work are changed, in accordance with embodiments of the present invention. In the example shown in FIG. 9, the arrow between the project B and the project C is selected. The list 61 is displayed in which lisa and tom in charge of both of the project B and the project C are shown. Further, lisa is selected in the list 61, whereby an allocation table 62 indicating allocations of an amount of work of lisa for the project B and the project C is displayed. From the project information shown in FIG. 2(b), the allocations of the amount of work of lisa are “80%” for the project B and “20%” for the project C. Therefore, the values are displayed in the allocation table 62. When a slider 63 located in the boundary between the projects is moved to the left and right, the allocations of the amounts of work of the projects are changed.

For example, when the user moves the slider 63 to the left, the allocation for the project B decreases and the allocation for the project C increases. On the other hand, when the user moves the slider to the right, the allocation for the project B increases and the allocation for the project C decreases. In this example, the user moves the slider 63 to the right to thereby change the allocation for the project B to “95%” and change the allocation for the project C to “5%”.

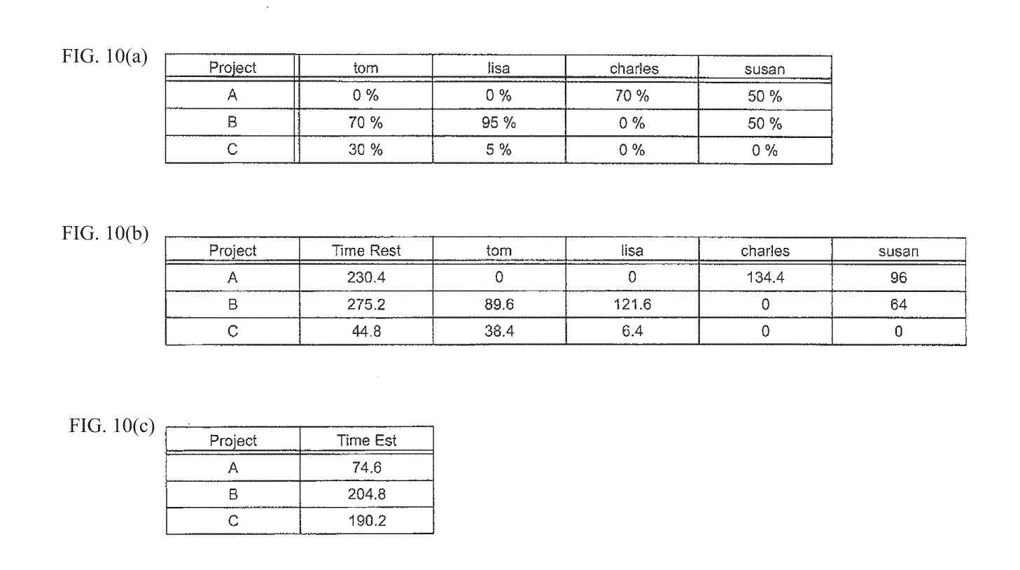

FIGS. 10(a) to 10(c) are diagrams showing examples of data used for calculating a progress difference after the change of the allocations of the amounts of work. First, FIG. 10(a) is a diagram showing an example of allocations of the amounts of work of the operators for the projects, in accordance with embodiments of the present invention. Compared with the example shown in FIG. 2(b), since the allocations of the amount of work of lisa are changed, the allocation for the project B is changed from “80%” to “95%” and the allocation for the project C is changed from “20%” to “5%”.

FIG. 10(b) is a diagram showing an example of amounts of work executable by the operators, in accordance with embodiments of the present invention. Since the allocations of the amount of work of lisa are changed, amounts of work executable by lisa before the project completion for the project B and the project C are changed. Specifically, in the example shown in FIG. 6(a), the executable amount of work is “102.4” concerning the project B. However, since the amount of work for the project B increases, the executable amount of work is calculated as “121.6” as shown in FIG. 10(b). In the example shown in FIG. 6(a), the executable amount of work is “25.6” concerning the project C. However, since the allocation for the project C decreases, as shown in FIG. 10(b), the executable amount of work is calculated as “6.4”. Concerning the project B and the project C, totals of amounts of work of the four operators are also changed. In the example shown in FIG. 6(a), the totals of amounts of work are respectively “256” and “64” concerning the project B and the project C. However, as shown in FIG. 10(b), the totals of amounts of work are respectively “275.2” and “44.8”.

FIG. 10(c) is a diagram showing an example of amounts of work that should be completed at the present point in time concerning the projects, in accordance with embodiments of the present invention. Since the allocations of the amount of work of lisa are changed, amounts of work that should be completed at the present point in time concerning the project B and the project C are changed. Since an entire amount of work of the project B and the project C is not changed, as shown in FIG. 6(c), the amounts of work that should be completed at the present point in time are respectively “480” and “235”. On the other hand, in this example, as shown in FIG. 10(b), amounts of work executable before the project completion in the project B and the project C are “275.2” and “44.8” as shown in FIG. 10(b). Therefore, in the project B, an amount of work that should be completed at the present point in time is calculated by 480−275.2 as “204.8”. In the project C, an amount of work that should be completed at the present point in time is calculated by 235−44.8 as “190.2”. For example, concerning the project C, the remaining amount of work is “65” as shown in FIG. 6(c). On the other hand, an amount of work executable before the project completion is “44.8” as shown in FIG. 10(b). Therefore, in the project C, an amount of work is insufficient by about 20.

In the project B, from the value of “Done” shown in FIG. 6(c), an amount of actually-completed work is “130”. An amount of work that should be completed at the present point in time is “204.8” as shown in FIG. 10(c). Therefore, a progress difference of the project B is calculated by 1−130/204.8 as “37%”. In the project C, from the value of “Done” shown in FIG. 6(c), an amount of actually-completed work is “170”. An amount of work that should be completed at the present point in time is “190.2” as shown in FIG. 10(c). Therefore, a progress difference of the project C is calculated by 1−170/190.2 as “11%”.

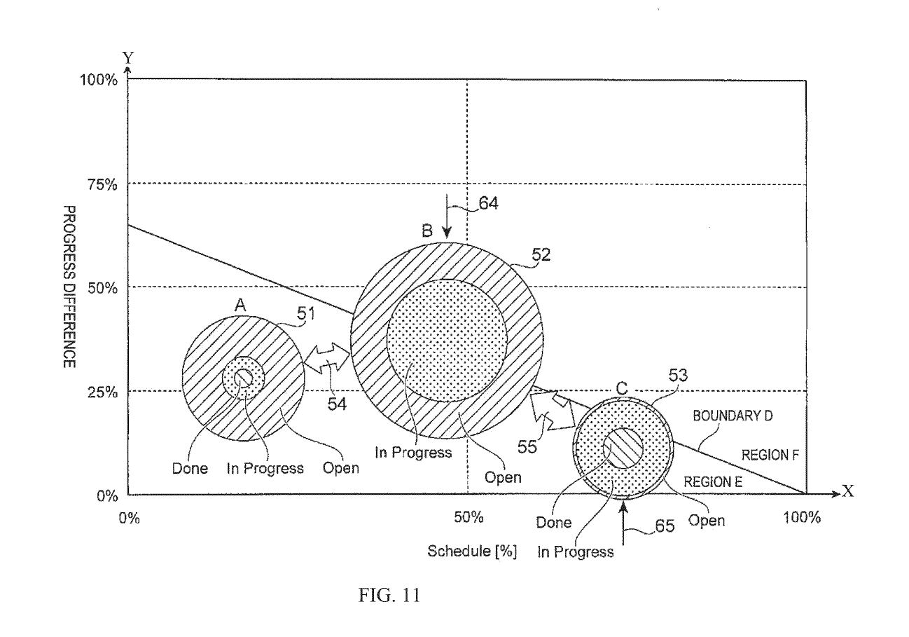

Additionally, by increasing the allocation for the project B and reducing the allocation for the project C as the allocations of the amount of work of lisa, compared with the example shown in FIG. 7, the progress difference of the project B changed from “42%” to “37%” and the progress difference of the project C changed from “1%” to “11%”. FIG. 11 is a diagram showing an example of a progress status graph after the allocation change of the amounts of work, in accordance with embodiments of the present invention. Compared with the graph shown in FIG. 8, since the progress differences of the project B and the project C change, as indicated by an arrow 64, the position of a circle corresponding to the project B is lowered. Accordingly, as indicated by an arrow 65, the position of a circle corresponding to the project C is raised.

According to the change in the positions of the project images, the association degree image is also updated. In this example, according to the change in the positions of the project B and the project C, the position of the arrow between the project B and the project C is also changed. However, even if the positions of the project B and the project C change, totals of the remaining amounts of work of the tasks, of which tom and lisa are in charge in the project B and the project C, do not change. Therefore, the thickness of the arrow between the project B and the project C does not change.

In this way, by changing the allocations of the amounts of work according to the movement of the slider, the positions of the project images move up and down on the progress status graph. Therefore, the user only has to check the positions of the project images after the change and determine how the allocations of the amounts of work should be changed. In this example, the allocations of the amounts of work are changed by the movement of the slider. However, for example, values indicating the allocations of the amounts of work may be directly input as numbers and changed.

Next, an example is explained in which allocations to the operators are changed by operation by the user. In this example, the input receiving unit 13 receives an operation input for selecting, as an operation target, together with project images, an association degree image associated with the project images. The user drags the project images up and down, whereby the input receiving unit 13 receives an operation input for moving the project images up and down in the progress status graph. According to such an operation input, progress differences of projects change on the progress status graph. Therefore, coordination of the operators is performed between the projects according to the change in the progress differences.

Additionally, when the user moves a project image upward, since a progress difference increases, the progress of a project is processed to be worse. In this case, the progress status calculating unit 14 performs processing for shifting assignment of the operators to another project. On the other hand, when the user moves a circle downward, since the progress difference decreases, the progress is processed to be better. In this case, since it is necessary to increase an amount of work to be processed, the progress status calculating unit 14 performs processing for shifting the assignment of the operators from the other project. In this example, in the following explanation, it is assumed that the user selects the arrow between the project B and the project C and moves the circle corresponding to the project B downward to thereby shift the assignment of the operators to the project B.

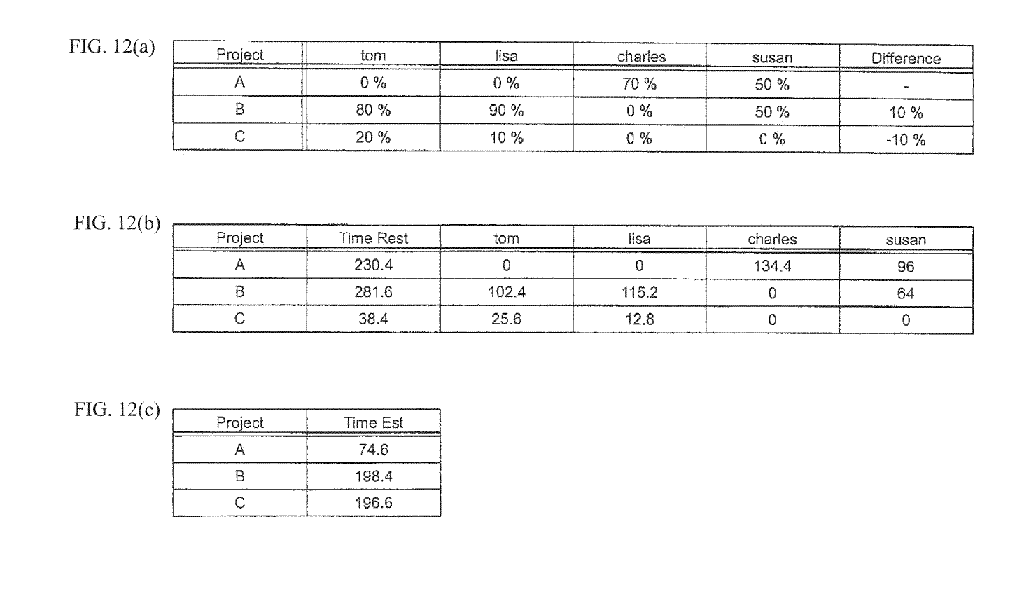

FIGS. 12(a) to 12(c) are diagrams showing examples of data used for calculating progress differences after a change of assignment of the operators. First, FIG. 12(a) is a diagram showing an example of allocations of amounts of work of the operators to the projects, in accordance with embodiments of the present invention. Compared with the example shown in FIG. 2(b), since assignment of the operators to the project B increases, the allocation of the amounts of work to the project B increases. Accordingly, the allocation of the amounts of work to the project C connected to the project B by the arrow decreases. That is, the assignment of the operators to the project C shifts to the project B. Specifically, concerning the project B, in the example shown in FIG. 2(b), the allocation of the amount of work of tom is “70%” and the allocation of the amount of work of lisa is “80%”. However, in the example shown in FIG. 12(a), an amount of an item “Difference” is added and the allocation of the amount of work of tom is changed to “80%” and the allocation of the amount of work of lisa is changed to “90%”. On the other hand, concerning the project C, in the example shown in FIG. 2(b), the allocation of the amount of work of tom is “30%” and the allocation of the amount of work of lisa is “20%”. However, in the example shown in FIG. 12(a), the amount of the item of “Difference” is reduced and the allocation of the amount of work of tom is changed to “20%” and the allocation of the amount of work of lisa is changed to “10%”.

FIG. 12(b) is a diagram showing an example of amounts of work executable by the operators, in accordance with embodiments of the present invention. The allocations of amounts of work to the project B and the project C are changed, whereby amounts of work executable before the project completion are changed for the project B and the project C. Specifically, in the example shown in FIG. 6(a), concerning the project B, the amount of work executable by tom is “89.6” and the amount of work executable by lisa is “102.4”. However, since the allocation of the amounts of work to the project B increases, as shown in FIG. 12(b), the amount of work executable by tom is calculated as “102.4” and the amount of work executable by lisa is calculated as “115.2”. In the example shown in FIG. 6(a), concerning the project C, the amount of work executable by tom is “38.4” and the amount of work executable by lisa is “25.6”. However, since the allocation of the amounts of work to the project C decreases, as shown in FIG. 12(b), the amount of work executable by tom is calculated as “25.6” and the amount of work executable by lisa is calculated as “12.8”.

Concerning the project B and the project C, totals of the amounts of work of the four operators are also changed. In the example shown in FIG. 6(a), the totals of the amounts of work are respectively “256” and “64” concerning the project B and the project C. However, as shown in FIG. 12(b), the totals of the amounts of work are respectively “281.6” and “38.4”. That is, concerning the project B, processing for increasing the amount of work executable before the project completion is performed. Concerning the project C, processing for reducing the amount of work executable before the project completion is performed.

FIG. 12(c) is a diagram showing an example of amounts of work that should be completed at the present point in time concerning the projects, in accordance with embodiments of the present invention. Since the allocations of the amounts of work to the project B and the project C are changed, the amounts of work that should be completed at the present point in time concerning the project B and the project C are changed. Since the entire amounts of work of the project B and the project C are not changed, as shown in FIG. 6(c), the entire amounts of work are respectively “480” and “235”. On the other hand, in this example, the amounts of work executable before the project completion in the project B and the project C are “281.6” and “38.4” as shown in FIG. 12(b). Therefore, in the project B, the amount of work that should be completed at the present point in time is calculated by 480−281.6 as “198.4”. In the project C, the amount of work that should be completed at the present point in time is calculated by 235−38.4 as “196.6”.

In the project B, from the value of “Done” shown in FIG. 6(c), the amount of actually-completed work is “130”. The amount of work that should be completed at the present point in time is “198.4” as shown in FIG. 12(c). Therefore, the progress difference of the project B is calculated by 1−130/198.4 as “34%”. In the project C, from the value of “Done” shown in FIG. 6(c), the amount of actually-completed work is “170”. The amount of work that should be completed at the present point in time is “196.6” as shown in FIG. 12(c). Therefore, the progress difference of the project C is calculated by 1−170/196.6 as “14%”.

Additionally, by moving the circle corresponding to the project B downward, compared with the example shown in FIG. 7, the progress difference of the project B changed from “42%” to “34%” and the progress difference of the project C changed from “1%” to “14%”.

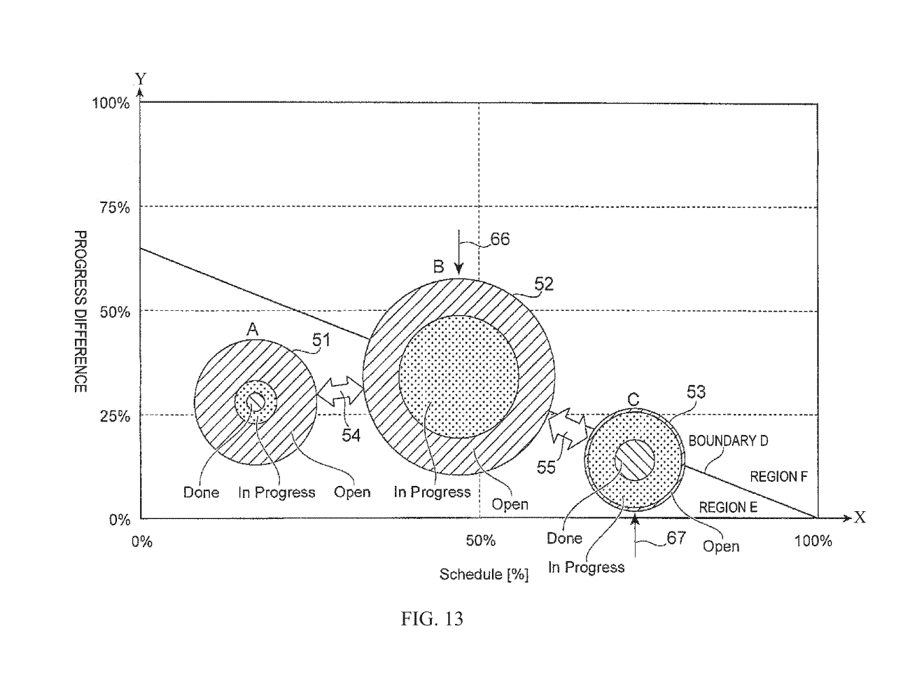

FIG. 13 is a diagram showing an example of the progress status graph after the change of the assignment of the operators, in accordance with embodiments of the present invention. Compared with the graph shown in FIG. 8, since the progress differences of the project B and the project C change, as indicated by an arrow 66, the position of the circle corresponding to the project B is lowered. Accordingly, as indicated by an arrow 67, the position of the circle corresponding to the project C is raised.

According to the change in the positions of the project images, the association degree image is also updated. In this example, according to the change in the positions of the project B and the project C, the position of the arrow between the project B and the project C is also changed. However, even if the positions of the projects B and the project C change, totals of the remaining amounts of work of the tasks, of which tom and lisa are in charge in the project B and the project C, do not change. Therefore, the thickness of the arrow between the project B and the project C does not change.

Further, the project A has a relation with the project B. However, since the arrow between the project A and the project B is not selected as an operation target, even if the circle of the project B is moved downward, the assignment of the operators to the project A does not change.

In this way, by dragging the positions of the circles corresponding to the projects up and down, since the progress differences of the projects change, coordination of the operators is performed between the projects. Therefore, after the coordination is performed, the user only has to check the assignment of the operators to the projects and the positions of the project images and determine how the assignment of the operators should be changed.

In this example, the circles are dragged up and down to change the progress differences, whereby the assignment of the operators to the projects changes. However, the change in the progress difference is not limited to such a configuration. For example, by moving the circles downward to reduce the progress differences, tasks having low priority levels in the projects may be excluded or amounts of work of tasks having low priority levels may be reduced. For example, in response to moving the circles upward to increase the progress differences, new tasks may be received or amounts of work of tasks may be increased. In this way, the project managing system 10 determines in advance what kind of processing is performed according to an operation input for the project images.

Next, an example is explained in which tasks in a project are changed according to operation by the user. In this example, the input receiving unit 13 receives an operation input to select, together with a project image, an association degree image associated with the project image. Further, the user drags an outermost radial boundary of the circle representing the project image either radially inward or radially outward which respectively decreases or increases the radius of the circle representing the project image, whereby the input receiving unit 13 receives an operation input for changing the size of the circle representing the project image. According to such an operation input, the size of the project changes and the tasks in the project changes.

Additionally, when the user enlarges the project image, the size of the project increases. For example, it is possible to receive new tasks and increase amounts of work of the tasks. On the other hand, when the user reduces the project image, the size of the project decreases. For example, tasks having low priority levels are excluded and amounts of work of the tasks having low priority levels decrease. In this example, in the following explanation, it is assumed that the user reduces the circle corresponding to the project B to thereby exclude a task of the project B.

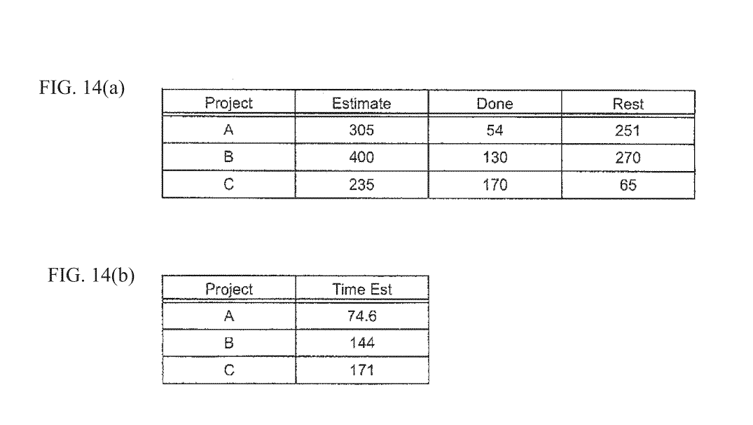

In the project information shown in FIG. 3, the task b5 has the lowest priority level in the project B. Therefore, the task b5 is excluded if the reduction in the size of project B is sufficient to reduce the “Estimate” total for project B in FIG. 3 from “480” to “400” or less. When the task b5 is excluded, the entire amount of work and the remaining amount of work of the project B decrease. FIGS. 14(a) and 14(b) are diagrams showing examples of data used for calculating a progress difference after the exclusion of the task b5.

FIG. 14(a) is a diagram showing an example of amounts of actually-completed work and the remaining amounts of work in the projects, in accordance with embodiments of the present invention. In the example shown in FIG. 6(c), the entire amount of work of the project B is “480”. However, since the task b5 is excluded, the entire amount of work decreases by “80”, which is the amount of work of the task b5, to be “400” as shown in FIG. 14(a). Similarly, in the example shown in FIG. 6(c), the remaining amount of work of the project B is “350”. However, since the task b5 is excluded, the remaining amount of work decreases by “80” to be “270” as shown in FIG. 14(a).

FIG. 14(b) is a diagram showing an example of amounts of work that should be completed at the present point in time concerning the projects, in accordance with embodiments of the present invention. Since the task b5 is excluded, the amounts of work that should be completed at the present point in time decreases. That is, concerning the project B, in the example shown in FIG. 6(b), the amount of work that should be completed at the present point in time is “224”. However, since the task b5 is excluded, the amount of work that should be completed at the present point in time decreases by “80” to be “144” as shown in FIG. 14(b).

In the project B, from the value of “Done” shown in FIG. 6(c), the amount of actually-completed work is “130”. The amount of work that should be completed at the present point in time is “144” as shown in FIG. 14(b). Therefore, the progress difference of the project B is calculated by 1−130/144 as “10%”. Additionally, by reducing the circle corresponding to the project B, compared with the case shown in FIG. 7, the progress difference of the project B decreases from “42%” to “10%”.

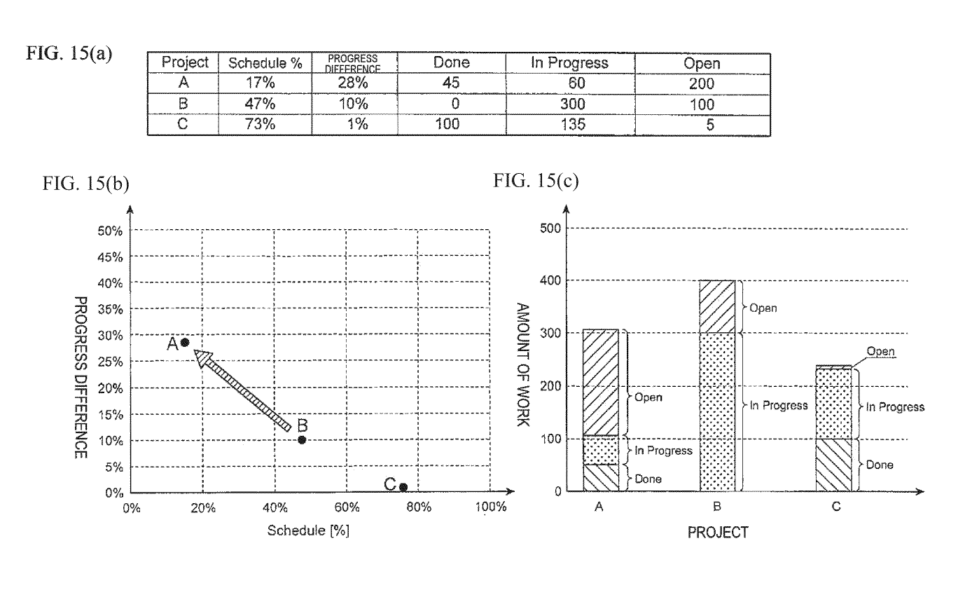

FIG. 15(a) is a diagram showing an example of values indicating positions where the project images of the projects are laid out and the sizes of the project images after the exclusion of the task b5, in accordance with embodiments of the present invention. FIGS. 15(b) and 15(c) are diagrams showing examples of graphs generated on the basis of values shown in FIG. 15(a), in accordance with embodiments of the present invention. In the example shown in FIG. 15(a), compared with the example shown in FIG. 7(a), the progress difference of the project B decreases from “42%” to “10%”. Since the task b5 is excluded, the amount of work of “Open” of the project B decreases from “180” to “100”. In the graph shown in FIG. 15(b), compared with the graph shown in FIG. 7(b), the position where the project image of the project B is laid out is lowered. Further, in the graph shown in FIG. 15(c), compared with the graph shown in FIG. 7(c), since the task b5 is excluded, the area of “Open” of the project B decreases.

In the project information shown in FIG. 3 and the relation search information shown in FIG. 4, it is indicated that the task a8 is present as a task that depends on the excluded task b5. Since the task b5 is excluded, the task a8 in the dependency relation with the task b5 becomes unexecutable. In this way, when a task in another project becomes unexecutable because a task is excluded, as shown in FIG. 15(b), an arrow is displayed to perform a warning. In the example shown in FIG. 15(b), an arrow is provided from a point corresponding to the project B toward a point corresponding to the project A to indicate that a task of the project A is affected by the exclusion of the task of the project B.

On the display unit 17, a message or the like indicating that the task a8 becomes unexecutable is displayed. When the user performs an operation input for accepting that the task a8 is not executed, processing for excluding the task a8 is performed.

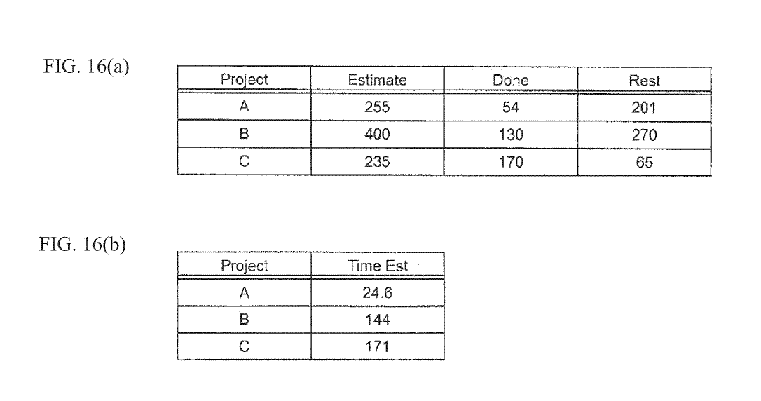

FIGS. 16(a) to 16(c) are diagrams showing examples of data used for calculating progress differences after the exclusion of the task a8, in accordance with embodiments of the present invention.

FIG. 16(a) is a diagram showing an example of amounts of actually-completed work and the remaining amounts of work in the projects after the exclusion of the task a8, in accordance with embodiments of the present invention. In the example shown in FIG. 6(c), the entire amount of work of the project A is “305”. However, since the task a8 is excluded, the entire amount of work decreases by “50”, which is the amount of work of the task a8, to be “255” as shown in FIG. 16(a). Similarly, in the example shown in FIG. 6(c), the remaining amount of work of the project A is “251”. However, since the task a8 is excluded, the remaining amount of work decreases by “50” to be “201” as shown in FIG. 16(a).

FIG. 16(b) is a diagram showing an example of amounts of work that should be completed at the present point in time concerning the projects after the exclusion of the task a8, in accordance with embodiments of the present invention. Since the task a8 is excluded, the amounts of work that should be completed at the present point in time decreases. That is, concerning the project A, in the example shown in FIG. 6(b), the amount of work that should be completed at the present point in time is “74.6”. However, since the task a8 is excluded, the amount of work that should be completed at the present point in time decreases by “50” to be “24.6” as shown in FIG. 16(b).

In the project A, from the value of “Done” shown in FIG. 6(c), the amount of actually-completed work is “54”. The amount of work that should be completed at the present point in time is “24.6” as shown in FIG. 16(b). Therefore, the progress difference of the project A is calculated by 1−54/24.6. However, since a calculated value exceeds 1, the progress difference is “0%”.

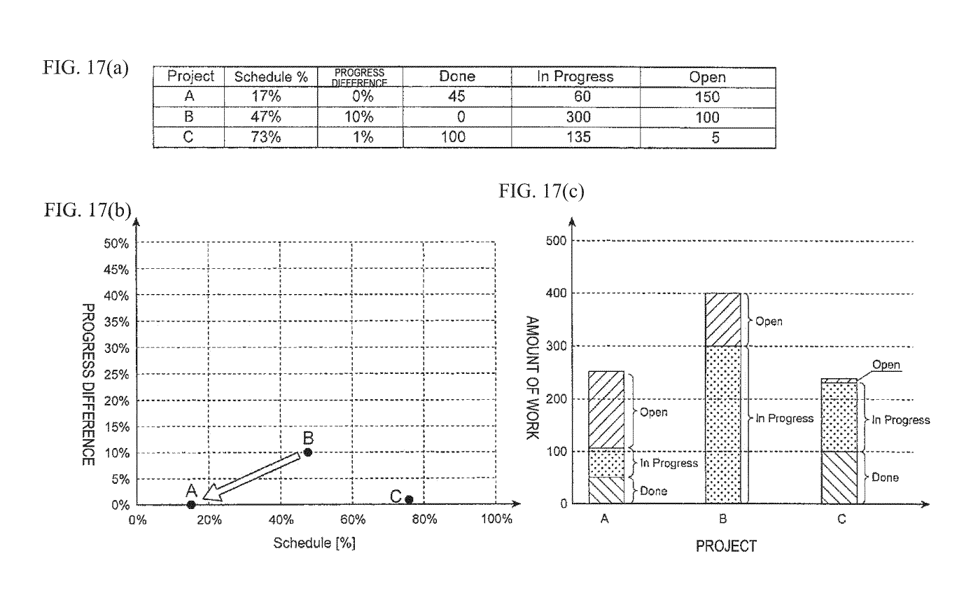

FIG. 17(a) is a diagram showing an example of values of positions where the project images of the projects are laid out and the sizes of the project images after the exclusion of the task a8, in accordance with embodiments of the present invention. FIGS. 17(b) and 17(c) are diagrams showing examples of graphs generated on the basis of the values shown in FIG. 17(a), in accordance with embodiments of the present invention. In the example shown in FIG. 17(a), compared with the example shown in FIG. 15(a), the progress difference of the project A decreases from “28%” to “0%”. Since the task a8 is excluded, the amount of work of “Open” of the project A decreases from “200” to “150”. In the graph shown in FIG. 17(b), compared with the graph shown in FIG. 15(b), the position where the project image of the project A is laid out is lowered. Further, in the graph shown in FIG. 17(c), compared with the graph shown in FIG. 15(c), since the task a8 is excluded, the region of “Open” of the project A decreases. Since the user accepts that the task a8 is excluded, the warning is released and the pattern of the arrow indicating the warning in the example shown in FIG. 15(b) changes. The arrow is displayed as shown in FIG. 17(b). A configuration for indicating that the warning is released is not limited to this. For example, a color of the arrow may be changed.

The operator in charge of both of the project A and the project B is susan. In the calculation of the association degree between the project A and the project B, amounts of work, of which susan is in charge, are totaled. Since susan is in charge of the excluded task a8 and task b5, the association degree between the project A and the project B decreases according to the exclusion of the tasks. Specifically, the remaining amount of work of the task a8 is “50” and the remaining amount of work of the task b5 is “80”. Therefore, although the association degree before the exclusion of the tasks is “240” as explained above, amounts of work of the excluded tasks are subtracted and the association degree decreases to “110”. Further, when a value is further added to the association degree because the task a8 depends on the task b5, the added value is also subtracted.

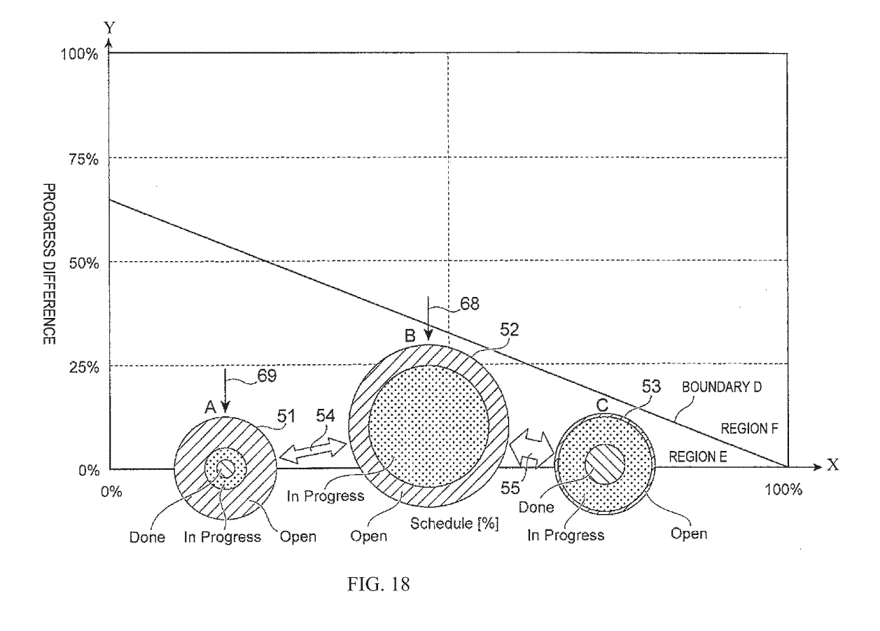

FIG. 18 is a diagram showing an example of a progress status graph after the task exclusion, in accordance with embodiments of the present invention. Compared with the graph shown in FIG. 8, the circle corresponding to the project B is reduced, whereby as indicated by an arrow 68, the position of the circle corresponding to the project B is lowered. As indicated by an arrow 69, the position of the circle corresponding to the project A is also lowered. Since the association degree between the project A and the project B decreases, the arrow (the arrow image 54) between the project A and the project B is thinned.

In this way, by changing the sizes of the circles corresponding to the projects, the tasks in the projects change. When a task is excluded, if a task related to the excluded task becomes unexecutable, it is warned that the task becomes unexecutable. The user accepts the warning, whereby the unexecutable task is also excluded. However, even if the user does not accept the warning, the unexecutable task may be excluded. In this example, the processing for removing a task is performed according to the operation input for reducing the project image. However, processing is not limited to such a configuration. For example, by reducing the project image, assignment of the operators to the project may be reduced. However, as explained above, the project managing system 10 determines in advance what kind of processing is performed according to an operation input for the project image.

As explained above, the processing in changing the progress status graph is explained with reference to the example. However, processing for a change is not limited to the configuration of the example. For example, when the user drags the circle corresponding to the project to the left and the right, the project period may be changed. That is, when the user drags the circle to the left, the project period increases. Therefore, for example, the amount of work that should be completed at the present point in time decreases and the progress difference decreases. When the user drags the circle to the right, since the project period decreases, for example, the amount of work that should be completed at the present point in time increases and the progress difference increases. Besides, for example, the user may cause the project managing system 10 to display tasks in the project and perform processing for changing priority levels of the tasks.

Further, in this embodiment, when the projects are unrelated to each other and the association degree is “0”, the association degree image is not displayed. However, even when the projects are unrelated, the association degree image may be displayed. For example, in the graph shown in FIG. 9, the association degree between the project A and the project C is “0”. However, the association degree image may be displayed in association with the two project images. In this case, for example, it is conceivable that the user selects the arrow between the project A and the project C and moves the slider 63 of the allocation table 62 to thereby change the allocation of the amounts of work between the project A and the project C.

Next, another example of the processing for displaying the progress status graph is explained. In this example, the operators measure actually spent times during execution of the projects. Every time work is performed, the user accumulates measured times for each project and records the measured times in the project information DB 11. The progress status calculating unit 14 calculates how large difference is present between “time accumulated to the present time” and the “amount of actually-completed work”. For example, when the “time accumulated to the present point in time” is larger than the “amount of actually-completed work”, time is spent more than scheduled because of, for example, the lack of skill of the operators. In such a case, the progress status calculating unit 14 further increases the “amount of work that should be completed at the present point in time” than the calculated value and then calculates the progress difference. This is because, since it is assumed that time is spent more than scheduled concerning the remaining work as well, in order to complete the project as scheduled, it is considered that the “amount of work that should be completed at the present point in time” has to be set larger than the calculated value.

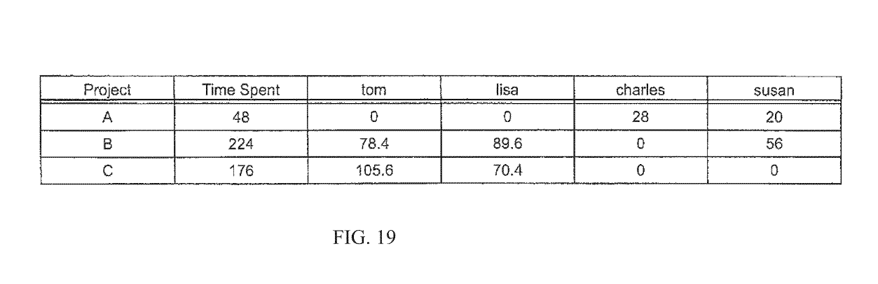

FIG. 19 is a diagram showing an example of times accumulated to the present point in time in the projects, in accordance with embodiments of the present invention. In the example shown in the figure, cumulative times actually spent to the present point in time for the projects by the four operators, tom, lisa, charles, and susan are shown. “Time spent” indicates totals of all the operators. In the example shown in FIG. 19, for example, concerning the project B, tom performs work for “78.4” hours to the present point in time. Concerning the project B, work for “224” hours is performed as a total of the four operators. Concerning the project B, when the “amount of actually-completed work” is set to “130” hours as shown in FIG. 6(c), the “time accumulated to the present point in time” is larger than the “amount of actually-completed work”. Therefore, the progress status calculating unit 14 increases the “amount of work that should be completed at the present point in time” by, for example, “10” and then calculates the progress difference of the project B. In this way, since the “amount of work that should be completed at the present point in time” increases, the progress difference increases.

As explained above, the project managing system 10 according to this embodiment displays the progress status graph to thereby present the progress statuses of the projects and, when there is association between the projects, presents a degree of association of the projects as well. Therefore, the user can easily grasp, in addition to the progress status of each project, to which degree the projects are related. The user can cause the project managing system 10 to temporarily change, on the displayed graph, the execution conditions of the projects such as the assignment of the operators to the projects and the tasks in the projects. The project managing system 10 immediately reflects a change by the user on the graph. Therefore, a trial for finding what kind of influence a change of a schedule has on the projects is performed on the graph. The user determines whether the change of the schedule is appropriate while checking the displayed graph.

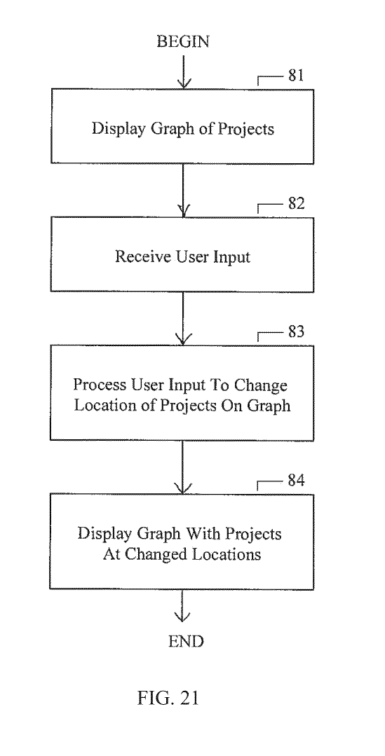

FIG. 21 is a flow chart depicting a method for managing a plurality of projects, in accordance with embodiments of the present invention. The flow chart of FIG. 21 summarizes embodiments of the present invention associated with the graphs of FIGS. 8, 9, 11, 13 and 18. The flow chart of FIG. 21 comprises steps 81-84.

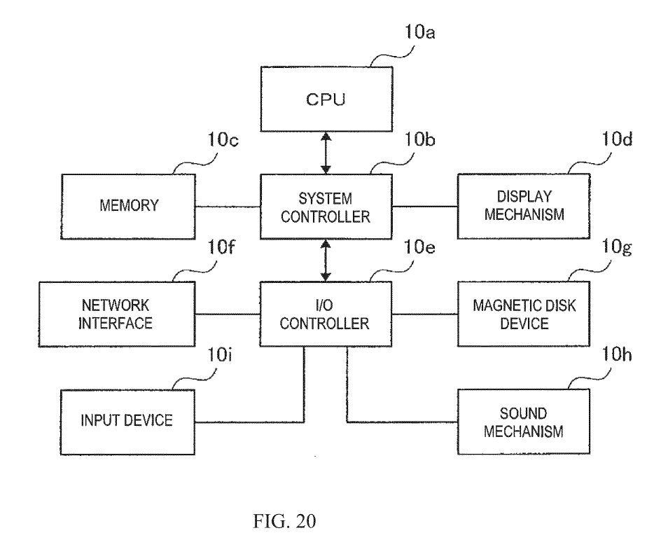

In step 81, a processor of a computer system (e.g., FIG. 20 to be described infra) displays a graph on a display screen of a display device of the computer system. The graph pertains to a present time. The graph comprises a X axis and a Y axis respectively denoting a coordinate X and a coordinate Y. The X and Y axes are mutually orthogonal. X is a project's schedule percent at the present time. Y is a project's progress difference at the present time. Each project is represented on the graph by a circle having a radial center whose position on the graph denotes a (X,Y) value for each project. The plurality of projects comprise a project B represented by a circle B and a project C represented by a circle C. An arrow image is disposed between, and points to, the circles B and C on the display screen. The arrow image denotes an association degree between the projects B and C.

In step 82, the processor receives a user input on the display screen. The user input comprises one or more actions of a mouse. The one or more actions of the mouse comprise either (i) a plurality of actions of mouse including an action of the mouse on the arrow image and subsequent actions of the mouse on displays, on the display screen, resulting from the action of the mouse on the arrow image or (ii) an action of the mouse on the circle B. In one embodiment, the user input does not comprise an action of the mouse on the circle C.

In step 83, the processor processes the user input to determine a change in respective Y values of the radial center of the circles B and C, wherein a magnitude of the change in the respective Y values of the radial center of the circles B and C is dependent upon the actions of the mouse.

In step 84, after the user input has been processed, the processor displays the plurality of projects with the radial center of the circles B and C at the changed Y values and with no change in the X values of the radial center of the circles B and C.

In one embodiment, the one or more actions of the mouse comprise the plurality of actions of the mouse, wherein the processing the user input comprises, in response to the subsequent actions of the mouse, changing a percent allocation of remaining work to be performed by one or more individuals on projects B and C, such that the one or more individuals are each responsible for one or more tasks in both project B and project C. The plurality of actions of the mouse may comprise: (i) a clicking of the mouse on the arrow image, resulting in a display, on the display screen, of the one or more individuals; (ii) a clicking of the mouse on one individual of the displayed one or more individuals, resulting in a display, on the display screen, of a table identifying a percent allocation of remaining work to be performed by the one individual on projects B and C; and (iii) a moving by the mouse of a slider disposed between projects B and C in the displayed table, which changes the percent allocation of remaining work to be performed by the one individual on projects B and C, wherein a summation of the percent allocation of remaining work to be performed by the one individual on projects B and C is 100% both before and after the moving of the slider by the mouse, and wherein the change in the respective Y values of the radial center of the circles B and C are in response to the change in the percent allocation of remaining work to be performed by the one individual on projects B and C.

In one embodiment, the one or more actions of the mouse comprise the action of the mouse on the circle B, subject to: (i) the action of the mouse on the circle B comprises a dragging by the mouse of the circle B in the +Y or −Y direction; (ii) processing the user input comprises, in response to the dragging by the mouse of the circle B in the +Y or −Y direction, changing a percent allocation of remaining work to be performed by one or more individuals on projects B and C, each individual being responsible for one or more tasks in both project B and project C; (iii) the change in the respective Y values of the radial center of the circles B and C are in response to the change in the percent allocation of remaining work to be performed by the one or more individuals on projects B and C; (iv) a summation of the percent allocation of remaining work to be performed by the one or more individuals on projects B and C is 100% both before and after the dragging by the mouse of the circle B in the +Y or −Y direction; and (v) the change in the respective Y values of the radial center of the circles B and C are of opposite polarity; i.e., the change in the respective Y values of the radial center of the circles B and C are either positive and negative respectively or negative and positive, respectively. The magnitude of the radius of circle B reflects a total amount of work performed by project B.

In one embodiment, the action of the mouse on the circle B comprises a dragging by the mouse of the circle B in the −Y direction, which results in a deletion of an existing lowest priority task from project B and a consequent reduction of the total amount of work performed by project B, wherein processing the user input further comprises: reducing the magnitude of the radius of circle B by an amount reflective of the reduction of the total amount of work performed by project B.

In one embodiment, the one or more actions of the mouse comprise the action of the mouse on the circle B, wherein the magnitude of the radius of each project's circle is indicative of a total amount of work of said each project, wherein the action of the mouse on the circle B comprises a dragging by the mouse of an outermost radial boundary of circle B radially inward which decreases the radius of the circle B to indicate a reduced total amount of work of project B, wherein said processing the user input comprises:
(i) in response to the decrease in the radius of circle B, deleting a task from project B;
(ii) determining that a task in project C is dependent on the task deleted from project B and consequently that the task in project C cannot be performed;
(iii) in response to said determining that the task project C cannot be performed, deleting the task from project C and in response, decreasing the radius of circle C to indicate a reduced total amount of work of project C; and
(iv) in response to the decrease of the radius of circles B and C, determining that the change in the Y value of the radial center of circles B and C are negative changes whose magnitude is dependent upon how much the dragging by the mouse of the outermost radial boundary of the circle B decreases the radius of circle B.

The hardware configuration of the project managing system 10 of FIG. 1 is explained via FIG. 20.

FIG. 20 is a diagram of a computer system showing a hardware configuration example suitable for configuring the project managing system 10, in accordance with embodiments of the present invention. Here, application of the hardware configuration to a computer is explained. The computer system shown in FIG. 20 includes a CPU (Central Processing Unit) 10a, which is an arithmetic unit, and a memory 10c, which is a main storage. The computer includes, as external devices, a magnetic disk device (HDD: Hard Disk Drive) 10g, a network interface 10f, a display mechanism 10d including a display device, a sound mechanism 10h, and an input device 10i such as a keyboard or a mouse.

In the configuration example shown in FIG. 20, the memory 10c and the display mechanism 10d are connected to the CPU 10a via a system controller 10b. The network interface 10f, the magnetic disk device 10g, the sound mechanism 10h, and the input device 10i are connected to the system controller 10b via an I/O controller 10e. The components are connected by various buses such as a system bus and an input/output bus.

In FIG. 20, a program of an OS and application programs are stored in the magnetic disk device 10g. These programs are read in the memory 10c and executed by the CPU 10a, whereby the functions of the progress status calculating unit 14, the association degree calculating unit 15, and the display control unit 16 in the project managing system 10 according to the embodiment are implemented. The project information DB 11 and the relation search information DB 12 are implemented by storage means such as the memory 10c and the magnetic disk device 10g. The display unit 17 is implemented by the display mechanism 10d. The input receiving unit 13 is implemented by the input device 10i.

Note that FIG. 20 merely illustrates the hardware configuration of the computer suitable for the application of the embodiment. The embodiment can be widely applied to apparatuses having a function of managing information concerning projects and displaying progress statuses of the projects and a relation between the projects. The embodiment is not limited to the configuration shown in the figure.

A computer program product of the present invention comprises a computer readable storage device (e.g., 10g) having computer readable program code stored therein, said program code containing instructions executable by a processor (e.g., 10a) of the computer system (e.g., FIG. 20) to implement the methods of the present invention.

A computer system (e.g., FIG. 20) of the present invention comprises a processor (e.g., 10a), a memory (e.g., 10c) coupled to the processor, and a computer readable storage device (e.g., 10g) coupled to the processor, said storage device containing program code executable by the processor via the memory to implement the methods of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention is explained above with reference to the embodiment, the technical scope of the present invention is not limited to the embodiment. It is evident for those skilled in the art that it is possible to variously change the embodiment and adopt alternative forms without departing from the spirit and the scope of the present invention.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

1-15. (canceled)

16. A method for managing a plurality of projects, said method comprising:
displaying, by a processor of a computer system, a graph on a display screen of a display device of the computer system, said graph pertaining to a present time, said graph comprising an X axis denoting a coordinate X and a Y axis denoting a coordinate Y, said X and Y axes being mutually orthogonal, said X being a project's schedule percent at the present time, said Y being a project's progress difference at the present time, each project being represented on the graph by a circle having a radial center whose position on the graph denotes a (X,Y) value for said each project, said plurality of projects comprising a project B represented by a circle B and a project C represented by a circle C, wherein an arrow image is disposed between, and points to, the circles B and C on the display screen, said arrow image denoting an association degree between the projects B and C;
said processor receiving a user input on the display screen, said user input comprising one or more actions of a mouse, said one or more actions of the mouse comprising either (i) a plurality of actions of mouse including an action of the mouse on the arrow image and subsequent actions of the mouse on displays, on the display screen, resulting from the action of the mouse on the arrow image or (ii) an action of the mouse on the circle B, wherein the user input does not comprise an action of the mouse on the circle C;
said processor processing the user input to determine a change in respective Y values of the radial center of the circles B and C, wherein a magnitude of the change in the respective Y values of the radial center of the circles B and C is dependent upon the actions of the mouse; and
after said processing the user input, said processor displaying the plurality of projects with the radial center of the circles B and C at the changed Y values and with no change in the X values of the radial center of the circles B and C.

17. The method of claim 16,
wherein the one or more actions of the mouse comprise the plurality of actions of the mouse,
wherein said processing the user input comprises, in response to the subsequent actions of the mouse, changing a percent allocation of remaining work to be performed by one or more individuals on projects B and C, said one or more individuals each responsible for one or more tasks in both project B and project C, and
wherein the change in the respective Y values of the radial center of the circles B and C are of opposite polarity.

18. The method of claim 17, wherein the plurality of actions of the mouse comprise:
a clicking of the mouse on the arrow image, resulting in a display, on the display screen, of the one or more individuals;
a clicking of the mouse on one individual of the displayed one or more individuals, resulting in a display, on the display screen, of a table identifying a percent allocation of remaining work to be performed by the one individual on projects B and C; and
a moving by the mouse of a slider disposed between projects B and C in the displayed table, which changes the percent allocation of remaining work to be performed by the one individual on projects B and C, wherein a summation of the percent allocation of remaining work to be performed by the one individual on projects B and C is 100% both before and after the moving of the slider by the mouse, and wherein the change in the respective Y values of the radial center of the circles B and C are in response to the change in the percent allocation of remaining work to be performed by the one individual on projects B and C.

19. The method of claim 16,
wherein the one or more actions of the mouse comprise the action of the mouse on the circle B,
wherein the action of the mouse on the circle B comprises a dragging by the mouse of the circle B in the +Y or −Y direction,
wherein said processing the user input comprises, in response to the dragging by the mouse of the circle B in the +Y or −Y direction, changing a percent allocation of remaining work to be performed by one or more individuals on projects B and C, each individual responsible for one or more tasks in both project B and project C,
wherein the change in the respective Y values of the radial center of the circles B and C are in response to the change in the percent allocation of remaining work to be performed by the one or more individuals on projects B and C,
wherein a summation of the percent allocation of remaining work to be performed by the one or more individuals on projects B and C is 100% both before and after the dragging by the mouse of the circle B in the +Y or −Y direction,
wherein the change in the respective Y values of the radial center of the circles B and C are of opposite polarity.

20. The method of claim 19,
wherein the magnitude of the radius of circle B reflects a total amount of work performed by project B,
wherein the action of the mouse on the circle B comprises a dragging by the mouse of the circle B in the −Y direction, which results in a deletion of an existing lowest priority task from project B and a consequent reduction of the total amount of work performed by project B, and
wherein said processing the user input further comprises: reducing the magnitude of the radius of circle B by an amount reflective of the reduction of the total amount of work performed by project B.

21. The method of claim 16,
wherein the one or more actions of the mouse comprise the action of the mouse on the circle B,
wherein the magnitude of the radius of each project's circle is indicative of a total amount of work of said each project,
wherein the action of the mouse on the circle B comprises a dragging by the mouse of an outermost radial boundary of circle B radially inward which decreases the radius of the circle B to indicate a reduced total amount of work of project B,
wherein said processing the user input comprises:
(i) in response to the decrease in the radius of circle B, deleting a task from project B;
(ii) determining that a task in project C is dependent on the task deleted from project B and consequently that the task in project C cannot be performed;
(iii) in response to said determining that the task project C cannot be performed, deleting the task from project C and in response, decreasing the radius of circle C to indicate a reduced total amount of work of project C; and
(iv) in response to the decrease of the radius of circles B and C, determining that the change in the Y value of the radial center of circles B and C are negative changes whose magnitude is dependent upon how much the dragging by the mouse of the outermost radial boundary of the circle B decreases the radius of circle B.

22. The method of claim 16, said method further comprising:
said processor calculating the association degree between the projects B and C as a sum of remaining work to be performed by the one or more individuals on projects B and C, said one or more individuals each responsible for one or more tasks in both project B and project C.

23. A computer program product, comprising a computer readable storage device having computer readable program code stored therein, said program code containing instructions executable by a processor of the computer system to implement a method for managing a plurality of projects, said method comprising:
said processor displaying a graph on a display screen of a display device of the computer system, said graph pertaining to a present time, said graph comprising an X axis denoting a coordinate X and a Y axis denoting a coordinate Y, said X and Y axes being mutually orthogonal, said X being a project's schedule percent at the present time, said Y being a project's progress difference at the present time, each project being represented on the graph by a circle having a radial center whose position on the graph denotes a (X,Y) value for said each project, said plurality of projects comprising a project B represented by a circle B and a project C represented by a circle C, wherein an arrow image is disposed between, and points to, the circles B and C on the display screen, said arrow image denoting an association degree between the projects B and C;
said processor receiving a user input on the display screen, said user input comprising one or more actions of a mouse, said one or more actions of the mouse comprising either (i) a plurality of actions of mouse including an action of the mouse on the arrow image and subsequent actions of the mouse on displays, on the display screen, resulting from the action of the mouse on the arrow image or (ii) an action of the mouse on the circle B, wherein the user input does not comprise an action of the mouse on the circle C;
said processor processing the user input to determine a change in respective Y values of the radial center of the circles B and C, wherein a magnitude of the change in the respective Y values of the radial center of the circles B and C is dependent upon the actions of the mouse; and
after said processing the user input, said processor displaying the plurality of projects with the radial center of the circles B and C at the changed Y values and with no change in the X values of the radial center of the circles B and C.

24. The computer program product of claim 23,
wherein the one or more actions of the mouse comprise the plurality of actions of the mouse,
wherein said processing the user input comprises, in response to the subsequent actions of the mouse, changing a percent allocation of remaining work to be performed by one or more individuals on projects B and C, said one or more individuals each responsible for one or more tasks in both project B and project C, and
wherein the change in the respective Y values of the radial center of the circles B and C are of opposite polarity.

25. The computer program product of claim 24, wherein the plurality of actions of the mouse comprise:
a clicking of the mouse on the arrow image, resulting in a display, on the display screen, of the one or more individuals;
a clicking of the mouse on one individual of the displayed one or more individuals, resulting in a display, on the display screen, of a table identifying a percent allocation of remaining work to be performed by the one individual on projects B and C; and
a moving by the mouse of a slider disposed between projects B and C in the displayed table, which changes the percent allocation of remaining work to be performed by the one individual on projects B and C, wherein a summation of the percent allocation of remaining work to be performed by the one individual on projects B and C is 100% both before and after the moving of the slider by the mouse, and wherein the change in the respective Y values of the radial center of the circles B and C are in response to the change in the percent allocation of remaining work to be performed by the one individual on projects B and C.

26. The computer program product of claim 23,
wherein the one or more actions of the mouse comprise the action of the mouse on the circle B,
wherein the action of the mouse on the circle B comprises a dragging by the mouse of the circle B in the +Y or −Y direction,
wherein said processing the user input comprises, in response to the dragging by the mouse of the circle B in the +Y or −Y direction, changing a percent allocation of remaining work to be performed by one or more individuals on projects B and C, each individual responsible for one or more tasks in both project B and project C,
wherein the change in the respective Y values of the radial center of the circles B and C are in response to the change in the percent allocation of remaining work to be performed by the one or more individuals on projects B and C,
wherein a summation of the percent allocation of remaining work to be performed by the one or more individuals on projects B and C is 100% both before and after the dragging by the mouse of the circle B in the +Y or −Y direction,
wherein the change in the respective Y values of the radial center of the circles B and C are of opposite polarity.

27. The computer program product of claim 26,
wherein the magnitude of the radius of circle B reflects a total amount of work performed by project B,
wherein the action of the mouse on the circle B comprises a dragging by the mouse of the circle B in the −Y direction, which results in a deletion of an existing lowest priority task from project B and a consequent reduction of the total amount of work performed by project B, and
wherein said processing the user input further comprises: reducing the magnitude of the radius of circle B by an amount reflective of the reduction of the total amount of work performed by project B.

28. The computer program product of claim 23,
wherein the one or more actions of the mouse comprise the action of the mouse on the circle B,
wherein the magnitude of the radius of each project's circle is indicative of a total amount of work of said each project,
wherein the action of the mouse on the circle B comprises a dragging by the mouse of an outermost radial boundary of circle B radially inward which decreases the radius of the circle B to indicate a reduced total amount of work of project B,
wherein said processing the user input comprises:
(i) in response to the decrease in the radius of circle B, deleting a task from project B;
(ii) determining that a task in project C is dependent on the task deleted from project B and consequently that the task in project C cannot be performed;
(iii) in response to said determining that the task project C cannot be performed, deleting the task from project C and in response, decreasing the radius of circle C to indicate a reduced total amount of work of project C; and
(iv) in response to the decrease of the radius of circles B and C, determining that the change in the Y value of the radial center of circles B and C are negative changes whose magnitude is dependent upon how much the dragging by the mouse of the outermost radial boundary of the circle B decreases the radius of circle B.

29. The computer program product of claim 23, said method further comprising:
said processor calculating the association degree between the projects B and C as a sum of remaining work to be performed by the one or more individuals on projects B and C, said one or more individuals each responsible for one or more tasks in both project B and project C.

30. A computer system, comprising a processor, a memory coupled to the processor, and a computer readable storage device coupled to the processor, said storage device containing program code executable by the processor via the memory to implement a method for managing a plurality of projects, said method comprising:
said processor displaying a graph on a display screen of a display device of the computer system, said graph pertaining to a present time, said graph comprising an X axis denoting a coordinate X and a Y axis denoting a coordinate Y, said X and Y axes being mutually orthogonal, said X being a project's schedule percent at the present time, said Y being a project's progress difference at the present time, each project being represented on the graph by a circle having a radial center whose position on the graph denotes a (X,Y) value for said each project, said plurality of projects comprising a project B represented by a circle B and a project C represented by a circle C, wherein an arrow image is disposed between, and points to, the circles B and C on the display screen, said arrow image denoting an association degree between the projects B and C;
said processor receiving a user input on the display screen, said user input comprising one or more actions of a mouse, said one or more actions of the mouse comprising either (i) a plurality of actions of mouse including an action of the mouse on the arrow image and subsequent actions of the mouse on displays, on the display screen, resulting from the action of the mouse on the arrow image or (ii) an action of the mouse on the circle B, wherein the user input does not comprise an action of the mouse on the circle C;
said processor processing the user input to determine a change in respective Y values of the radial center of the circles B and C, wherein a magnitude of the change in the respective Y values of the radial center of the circles B and C is dependent upon the actions of the mouse; and
after said processing the user input, said processor displaying the plurality of projects with the radial center of the circles B and C at the changed Y values and with no change in the X values of the radial center of the circles B and C.

31. The computer system of claim 30,
wherein the one or more actions of the mouse comprise the plurality of actions of the mouse,
wherein said processing the user input comprises, in response to the subsequent actions of the mouse, changing a percent allocation of remaining work to be performed by one or more individuals on projects B and C, said one or more individuals each responsible for one or more tasks in both project B and project C, and
wherein the change in the respective Y values of the radial center of the circles B and C are of opposite polarity.

32. The computer system of claim 31, wherein the plurality of actions of the mouse comprise:
a clicking of the mouse on the arrow image, resulting in a display, on the display screen, of the one or more individuals;
a clicking of the mouse on one individual of the displayed one or more individuals, resulting in a display, on the display screen, of a table identifying a percent allocation of remaining work to be performed by the one individual on projects B and C; and
a moving by the mouse of a slider disposed between projects B and C in the displayed table, which changes the percent allocation of remaining work to be performed by the one individual on projects B and C, wherein a summation of the percent allocation of remaining work to be performed by the one individual on projects B and C is 100% both before and after the moving of the slider by the mouse, and wherein the change in the respective Y values of the radial center of the circles B and C are in response to the change in the percent allocation of remaining work to be performed by the one individual on projects B and C.

33. The computer system of claim 30,
wherein the one or more actions of the mouse comprise the action of the mouse on the circle B,
wherein the action of the mouse on the circle B comprises a dragging by the mouse of the circle B in the +Y or −Y direction,
wherein said processing the user input comprises, in response to the dragging by the mouse of the circle B in the +Y or −Y direction, changing a percent allocation of remaining work to be performed by one or more individuals on projects B and C, each individual responsible for one or more tasks in both project B and project C,
wherein the change in the respective Y values of the radial center of the circles B and C are in response to the change in the percent allocation of remaining work to be performed by the one or more individuals on projects B and C,
wherein a summation of the percent allocation of remaining work to be performed by the one or more individuals on projects B and C is 100% both before and after the dragging by the mouse of the circle B in the +Y or −Y direction,
wherein the change in the respective Y values of the radial center of the circles B and C are of opposite polarity.

34. The computer system of claim 33,
wherein the magnitude of the radius of circle B reflects a total amount of work performed by project B,
wherein the action of the mouse on the circle B comprises a dragging by the mouse of the circle B in the −Y direction, which results in a deletion of an existing lowest priority task from project B and a consequent reduction of the total amount of work performed by project B, and
wherein said processing the user input further comprises: reducing the magnitude of the radius of circle B by an amount reflective of the reduction of the total amount of work performed by project B.

35. The computer system of claim 30,
wherein the one or more actions of the mouse comprise the action of the mouse on the circle B,
wherein the magnitude of the radius of each project's circle is indicative of a total amount of work of said each project,
wherein the action of the mouse on the circle B comprises a dragging by the mouse of an outermost radial boundary of circle B radially inward which decreases the radius of the circle B to indicate a reduced total amount of work of project B,
wherein said processing the user input comprises:
(i) in response to the decrease in the radius of circle B, deleting a task from project B;
(ii) determining that a task in project C is dependent on the task deleted from project B and consequently that the task in project C cannot be performed;
(iii) in response to said determining that the task project C cannot be performed, deleting the task from project C and in response, decreasing the radius of circle C to indicate a reduced total amount of work of project C; and
(iv) in response to the decrease of the radius of circles B and C, determining that the change in the Y value of the radial center of circles B and C are negative changes whose magnitude is dependent upon how much the dragging by the mouse of the outermost radial boundary of the circle B decreases the radius of circle B.
